(19) United States
(12) Patent Application Publication
(10) Pub. No.: US 2009/0070237 A1
(43) Pub. Date: Mar. 12, 2009

(54) DATA RECONCILIATION

(75) Inventors: Melvin Lew, Jersey City, NJ (US); Syed Husain, Jersey City, NJ (US); Perry Fotinatos, Jersey City, NJ (US); John Woschinko, Jersey City, NJ (US)

Correspondence Address: LEE & HAYES, PLLC, 601 W. RIVERSIDE AVENUE, SUITE 1400, SPOKANE, WA, 99201, US

(73) Assignee: Goldman Sachs& Co., New York, NY (US)

(21) Appl. No.: 11/853,576

(22) Filed: Sep. 11, 2007

(51) Int. Cl. G06Q 10/00; G06F 17/30

(52) U.S. Cl. 705/28

(57) ABSTRACT

Reconciling corresponding data reported by multiple data sources and pertaining to hardware, software, and telecommunications assets distributed throughout an organization is described. In one aspect, a reconciliation framework receives data maintained by a first data source and pertaining to a portion of the hardware, software, and telecommunications assets distributed throughout the organization. The reconciliation framework then also receives data maintained by a second data source and pertaining to the portion of the hardware, software, and telecommunications assets distributed throughout the organization. The reconciliation framework then compares the data maintained by the first data source to the data maintained by the second data source effective to determine differences between the data maintained by the first data source and the data maintained by the second data source.

### TECHNICAL FIELD

This disclosure relates to reconciling data pertaining to hardware, software, and telecommunications assets distributed throughout an organization. BACKGROUND

In the wake of recent disasters—both natural and man-made—business continuity planning has become increasingly important to many organizations. Disasters such as floods, hurricanes, tsunamis, tornadoes, terrorist attacks, prolonged power outages, and the like can cause significant disruptions to an organization. Business continuity planning (or BCP) is a methodology used to create a plan for how an organization will resume partially or completely interrupted critical function(s) within a predetermined time after a disaster or disruption. BCP was used in many industries to anticipate and handle potential computing problems introduced by crossing into the new millennium in 2000, a situation generally known as the Y2k problem. Regulatory agencies subsequently required certain important industries—power, telecommunication, health, and financial—to formalize BCP manuals to protect the public. Those new regulations are often based on the formalized standards defined under ISO/IEC 17799 or BS 7799.

Although business focus on BCP arguably waned somewhat following the Y2K transition (mainly due to its success), the lack of interest unequivocally ended on Sep. 11, 2001, when simultaneous terrorist attacks devastated lower New York City. Many critical functions for many different organizations were lost and not restored for sometime. This tragic event changed the worst case scenario paradigm for business continuity planning.

Today, BCP may be a part of a larger organizational effort to reduce operational risk associated with poor information security controls, and thus has a number of overlaps with the practice of risk management. However, the scope of BCP extends beyond information security only. Part of good business continuity planning includes an accurate accounting of computing assets and resources that an organization possesses. Many organizations track their hardware assets by manually placing bar code labels on computers, monitors, etc. and then scanning those labels to create an electronic record of the assets. Unfortunately, over time, this data becomes stale as computers and monitors are moved or replaced, and applications are updated, deleted, or changed out. Moreover, the process of collecting the information initially is manually intensive and prone to inaccuracies.

Accordingly, there remains a need for improved techniques in building and maintaining a current and accurate inventory of computing resources within an organization.

### SUMMARY

Reconciling corresponding data reported by multiple data sources and pertaining to hardware, software, and telecommunications assets distributed throughout an organization is described. In one aspect, a reconciliation framework receives data maintained by a first data source and pertaining to a portion of the hardware, software, and telecommunications assets distributed throughout the organization. The reconciliation framework then also receives data maintained by a second data source and pertaining to the portion of the hardware, software, and telecommunications assets distributed throughout the organization. The reconciliation framework then compares the data maintained by the first data source to the data maintained by the second data source effective to determine differences between the data maintained by the first data source and the data maintained by the second data source.

### BRIEF DESCRIPTION OF THE CONTENTS

The detailed description is described with reference to the accompanying figures. In the figures, the left-most digit(s) of a reference number identifies the figure in which the reference number first appears. The use of the same reference numbers in different figures indicates similar or identical items.

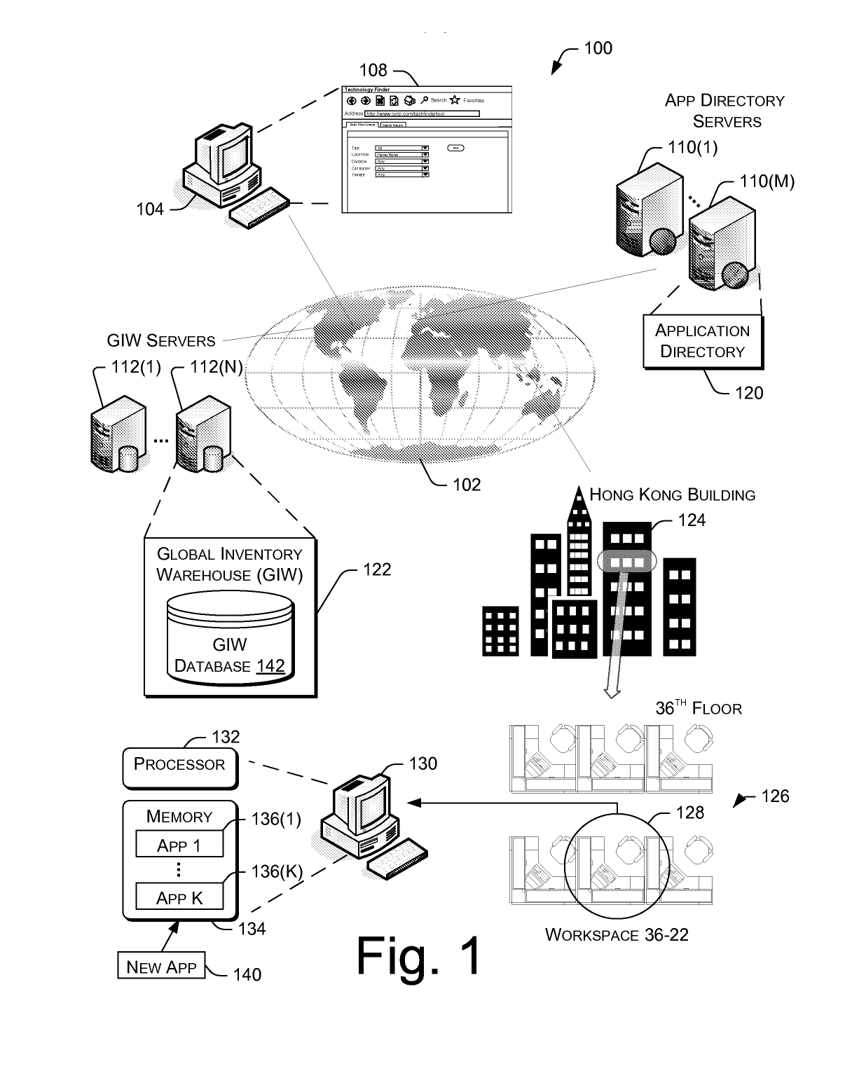

FIG. 1 illustrates an exemplary environment in which an architecture for building, maintaining, and managing an inventory of hardware, software, and telecommunications assets distributed throughout an organization may be implemented. This architecture also enables periodic reconciliation of the inventory as well as information about the assets.

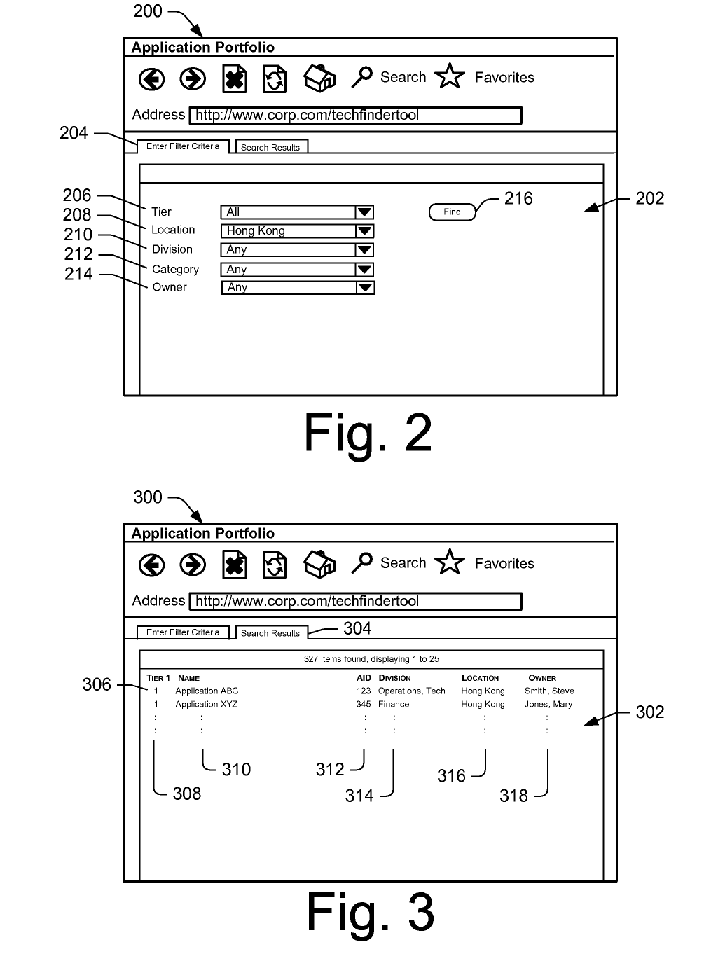

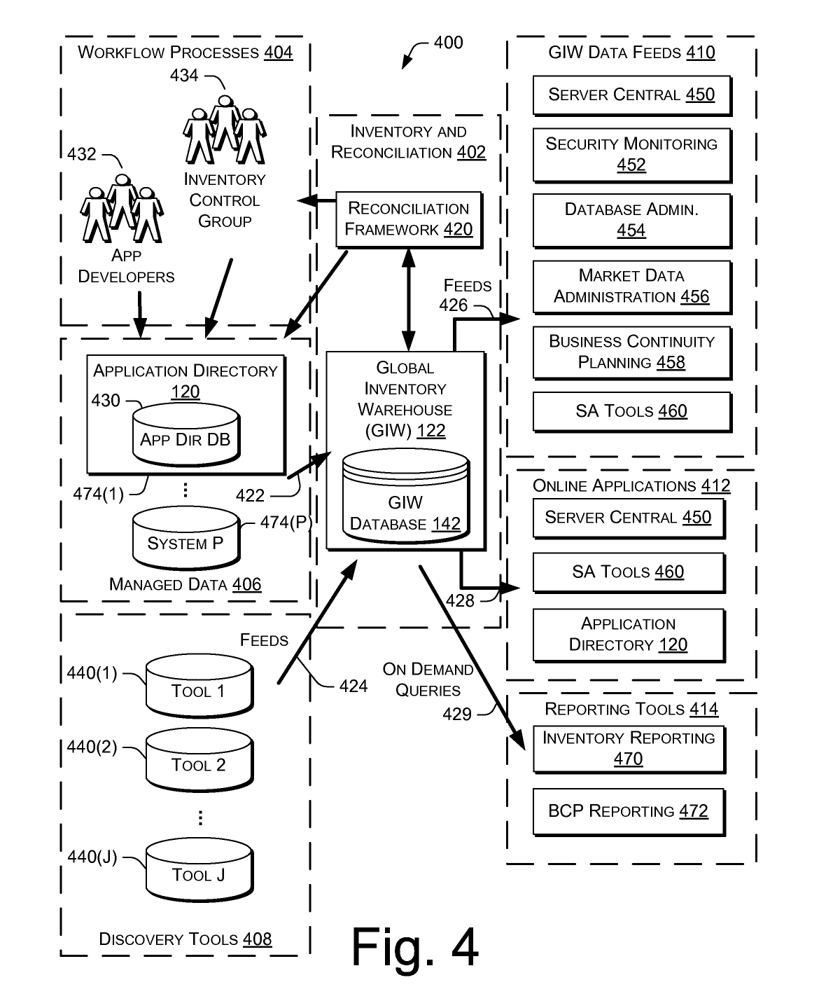

FIGS. 2-3 show renderings of an exemplary user interface to manage a portfolio of applications in an inventory of applications and related assets. In FIG. 2, the UI facilitates entry of search criteria for applications distributed throughout the organization. In FIG. 3, the UI presents a listing of applications satisfying the submitted search criteria.

FIG. 4 illustrates one exemplary implementation of the architecture for building, maintaining, managing, and reconciling an inventory of hardware, software, and telecommunications assets. This figure also illustrates data flow among various systems and processes in the architecture.

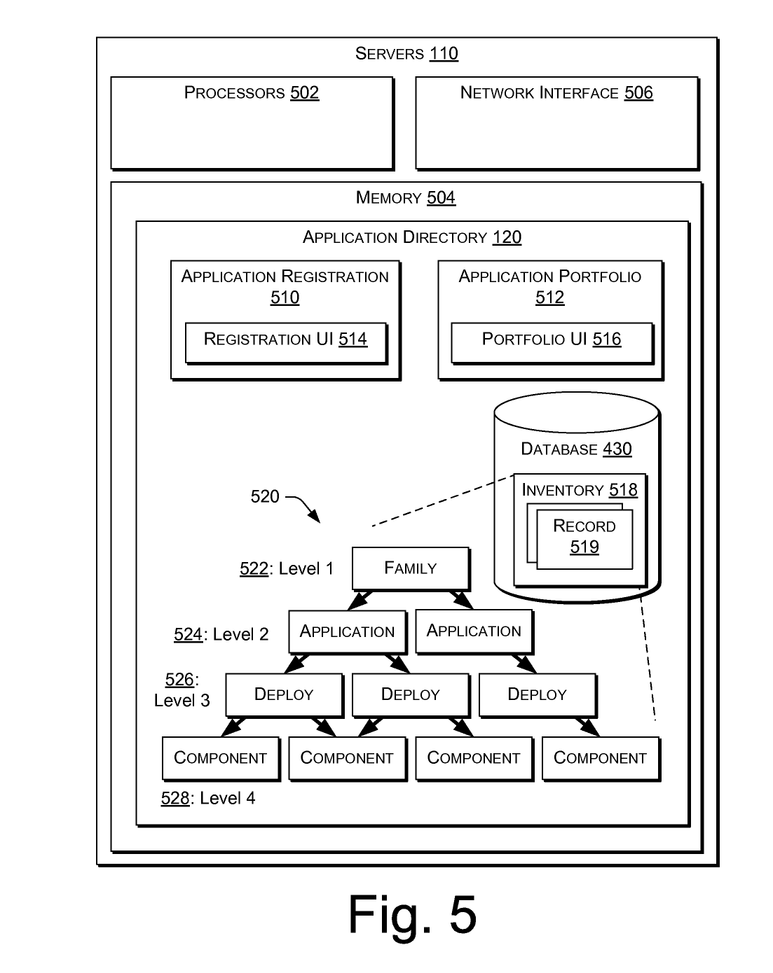

FIG. 5 is a functional block diagram of an application directory implemented on a computing system.

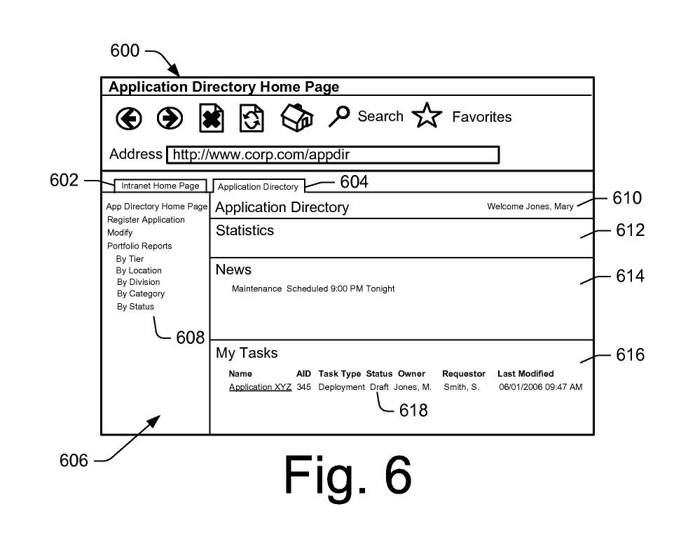

FIG. 6 is a rendering of an example home page for the application directory.

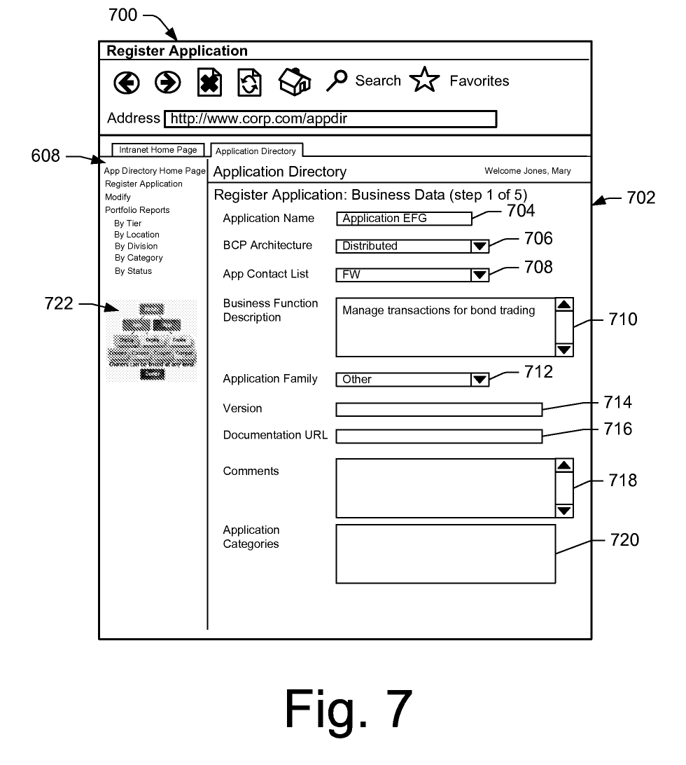

FIGS. 7-11 show a series of renderings of example interfaces to facilitate an automated and systematic registration process for registering applications being deployed in the organization.

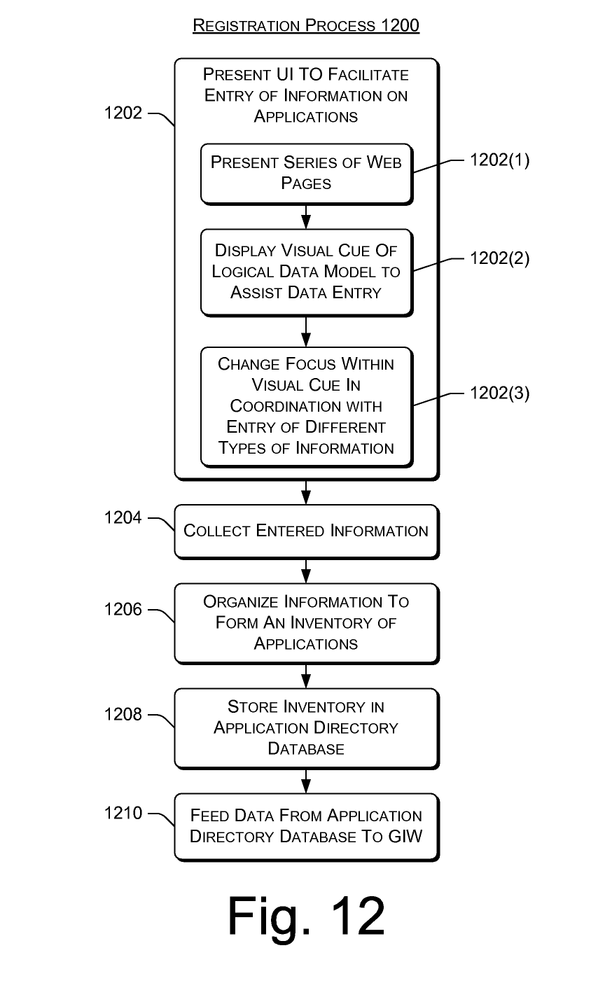

FIG. 12 is a flow diagram of an exemplary process for registering an application with the application directory.

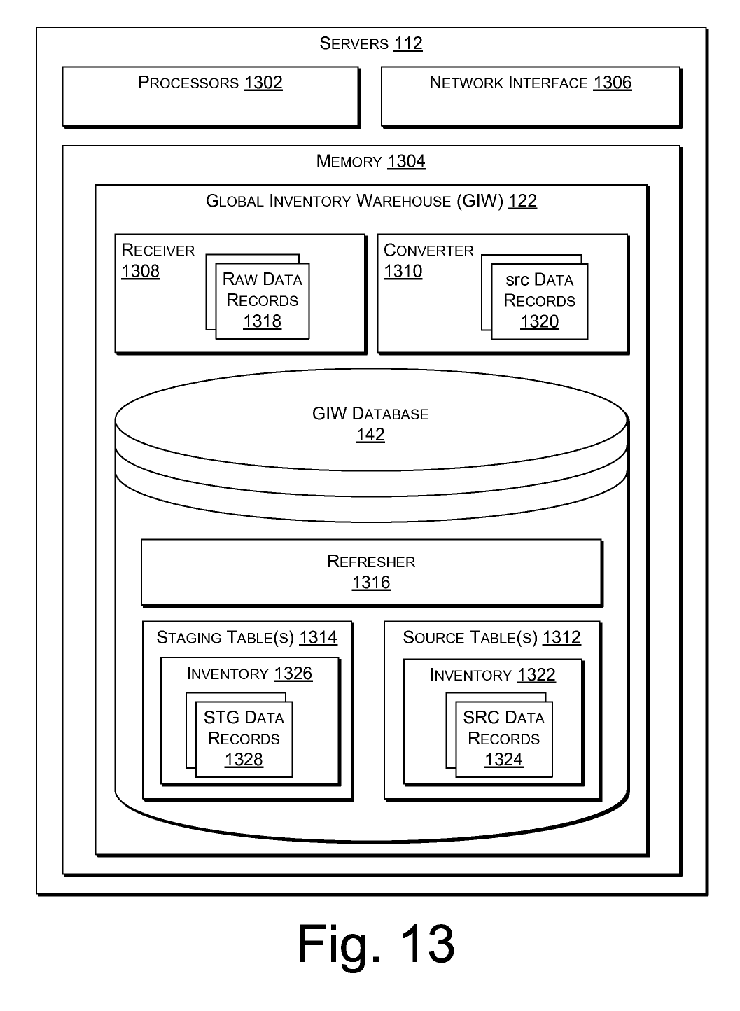

FIG. 13 is a functional block diagram of a global inventory warehouse (GIW) implemented on a computing system.

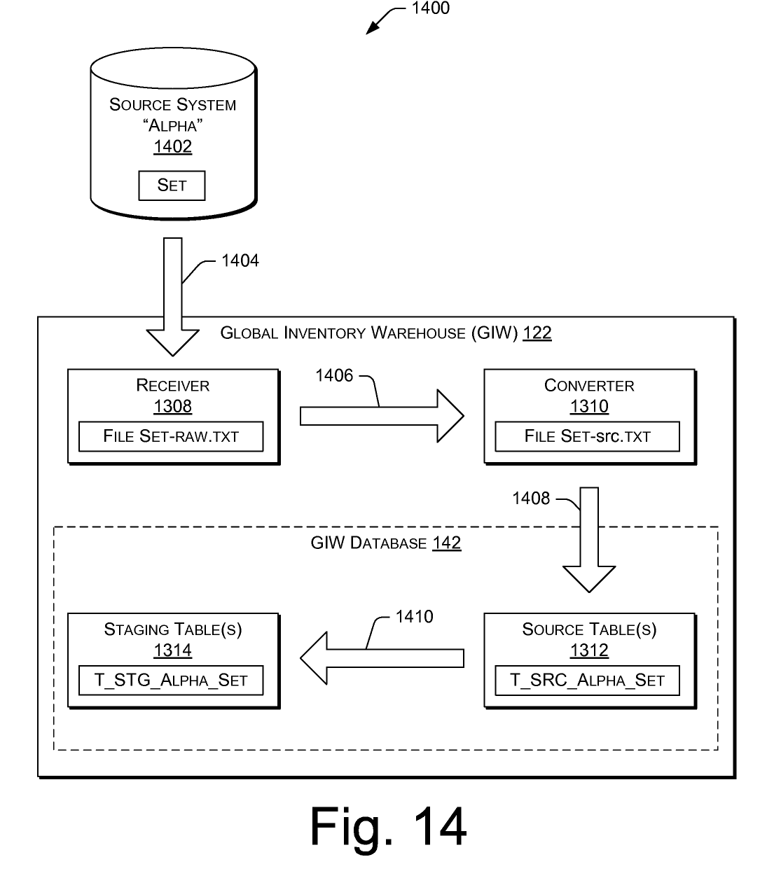

FIG. 14 illustrates an exemplary process for receiving a batch of data records from a source system and storing the batch in a GIW database.

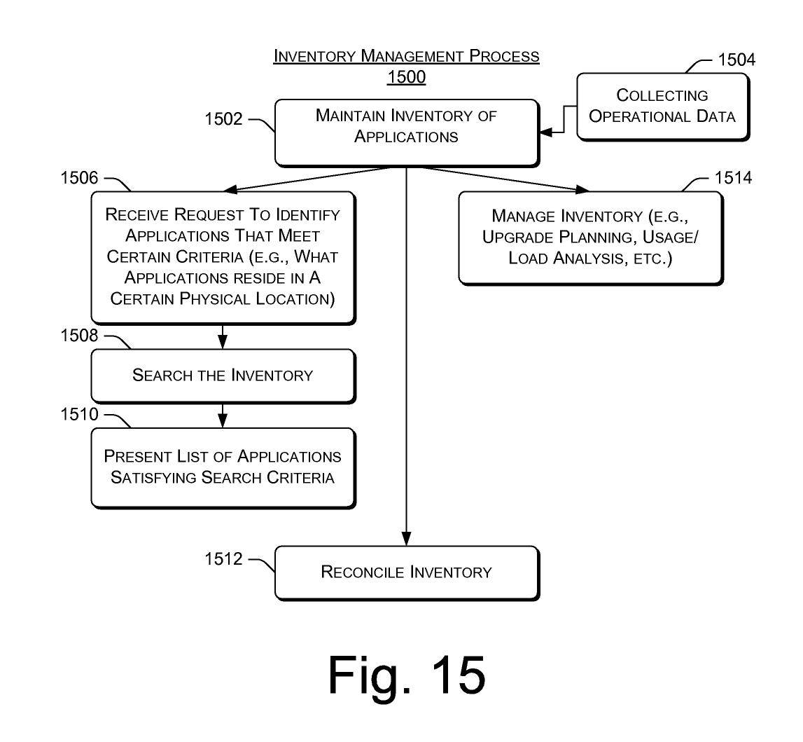

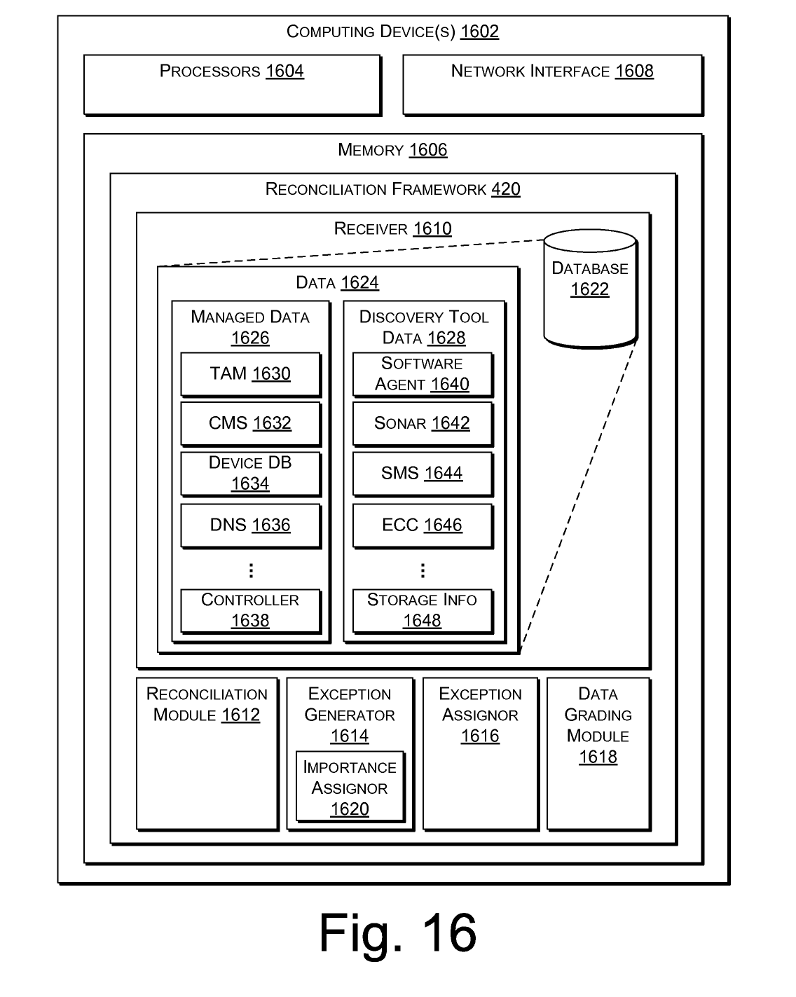

FIG. 15 is a flow diagram of an exemplary process for managing the hardware, software, and telecommunications assets in the architecture of FIG. 4.

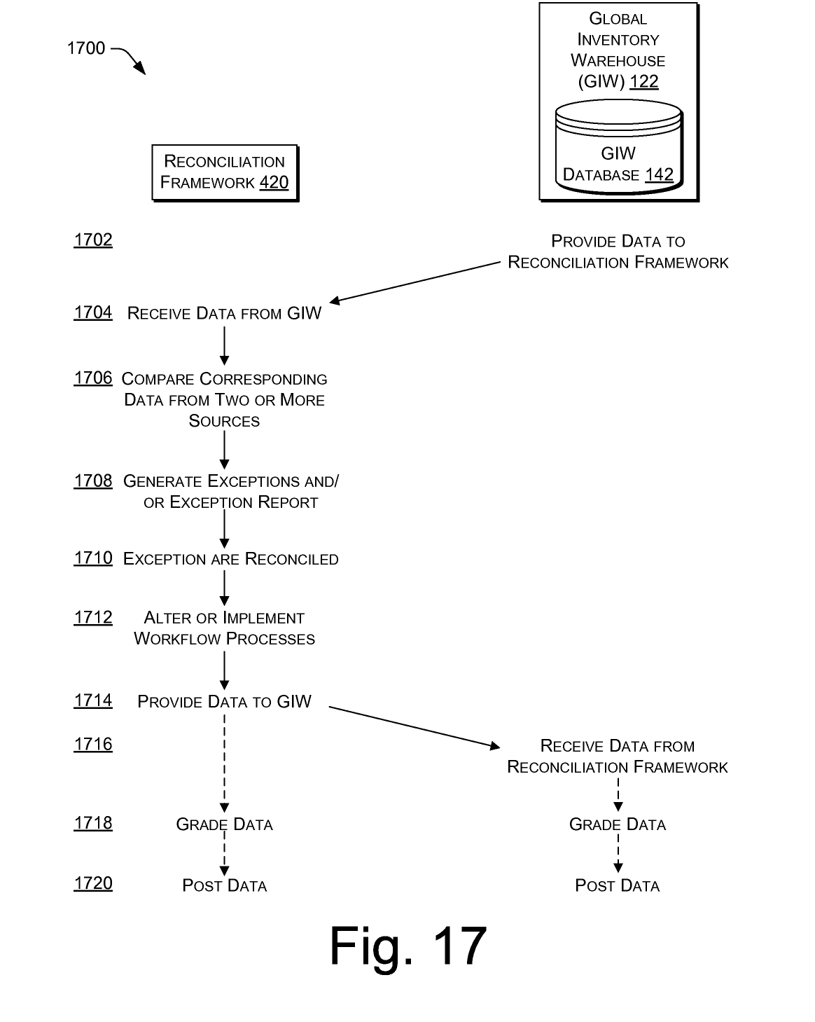

FIG. 16 is a functional block diagram of a reconciliation framework implemented on a computing system.

FIG. 17 is a flow diagram of an exemplary process for receiving data from a global inventory warehouse and reconciling the data.

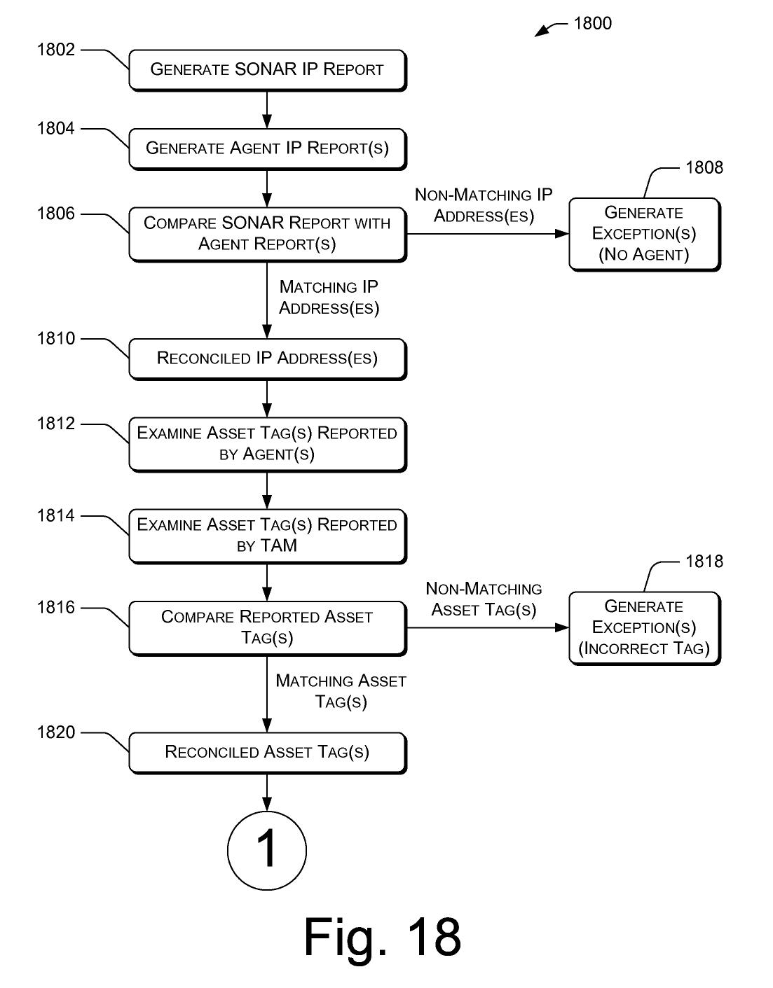

FIGS. 18-20 are flow diagrams of an exemplary process for reconciling data pertaining to hardware assets distributed throughout the organization.

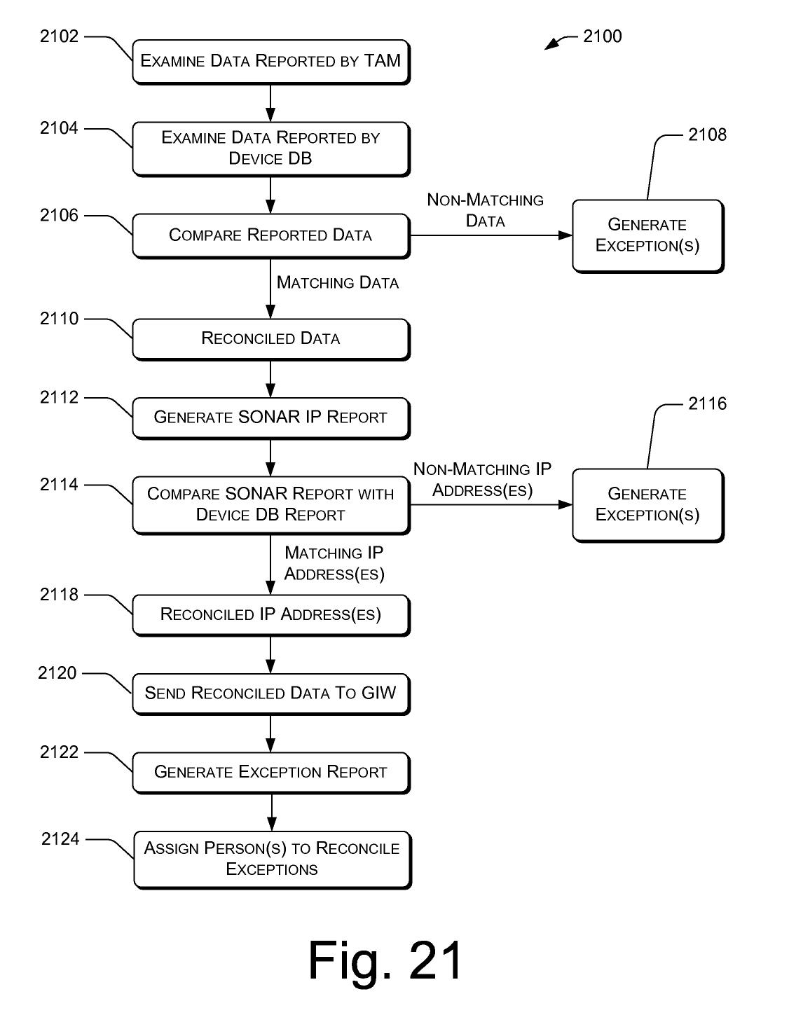

FIG. 21 is a flow diagram of another exemplary process for reconciling data pertaining to hardware assets distributed throughout the organization.

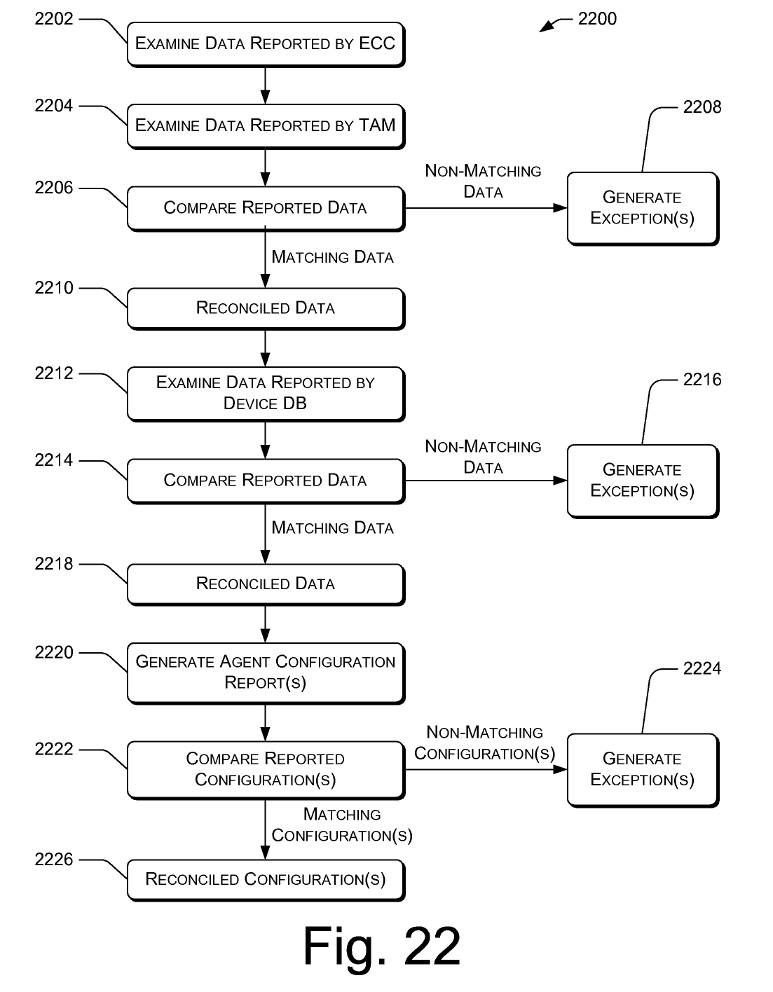

FIG. 22 is a flow diagram of an exemplary process for reconciling data pertaining to storage-related assets distributed throughout the organization.

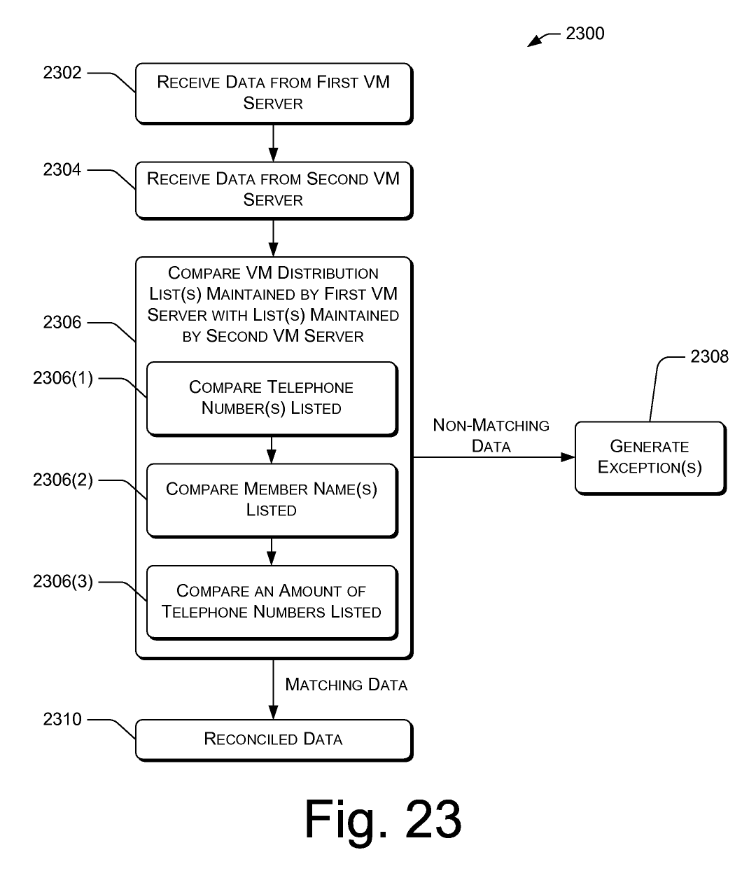

FIG. 23 is a flow diagram of an exemplary process for reconciling data pertaining to voicemail or email distribution lists maintained by multiple servers.

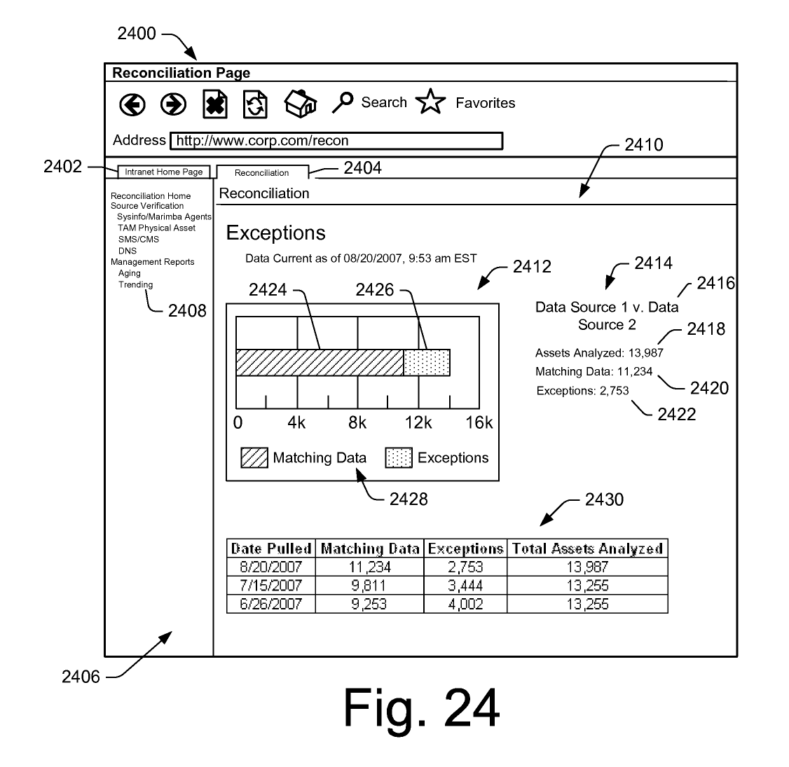

FIG. 24 is a rendering of an example reconciliation page that reports on reconciliation information.

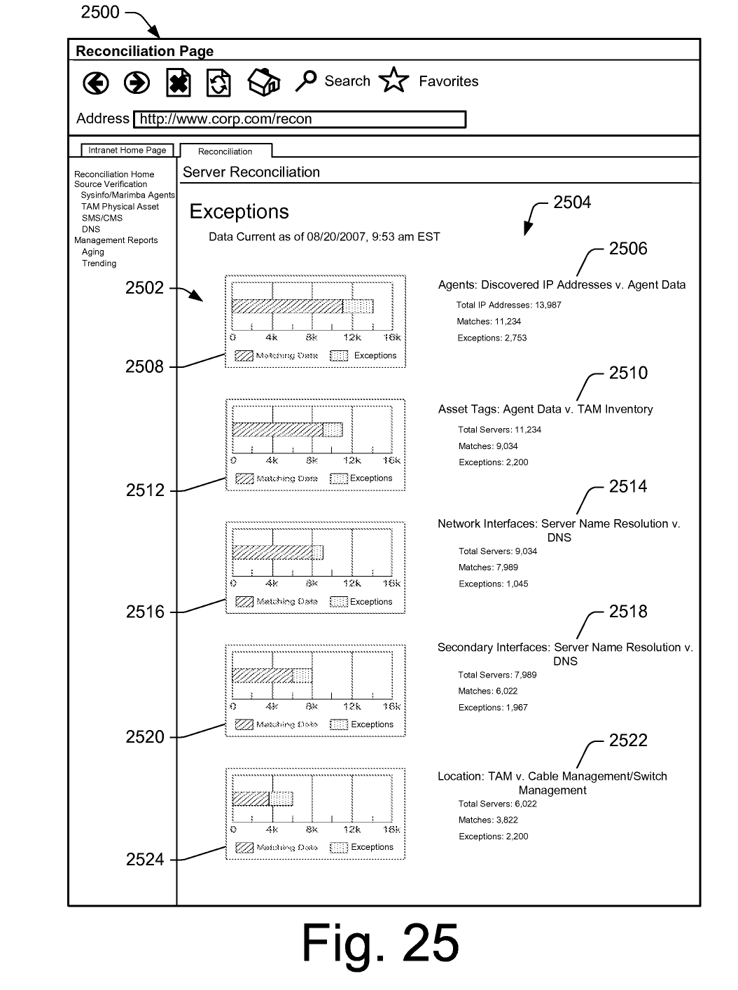

FIG. 25 is a rendering of another example reconciliation page that reports on reconciliation information. This reported reconciliation information employs a cascading approach, as illustrated.

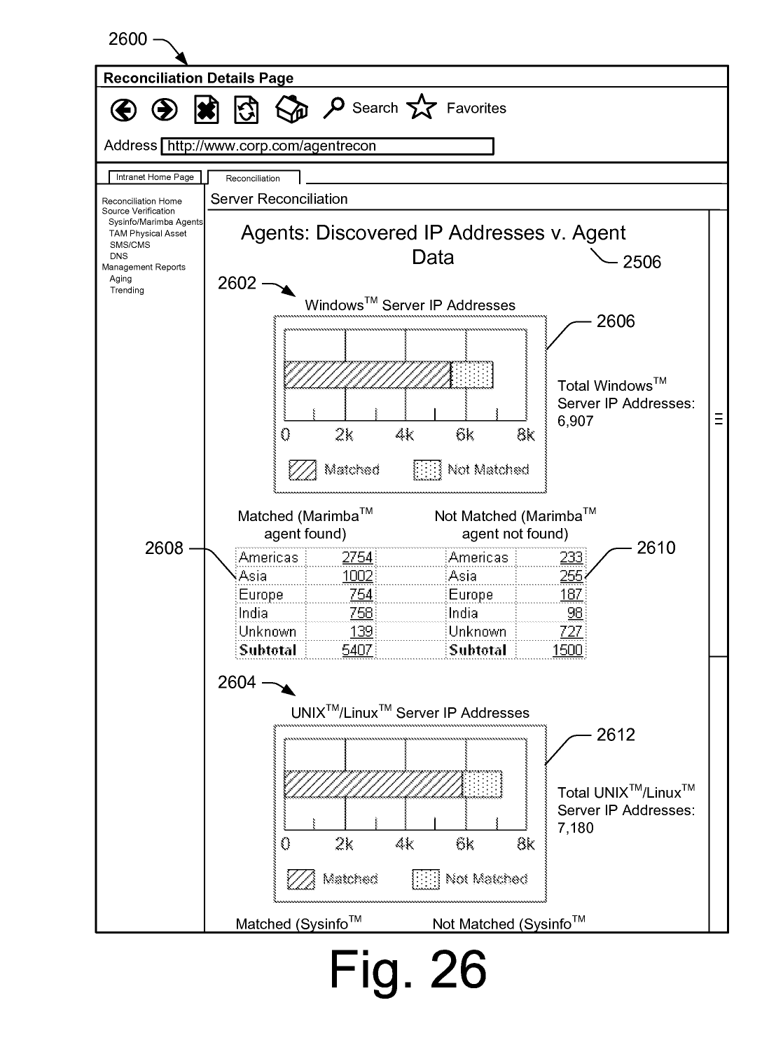

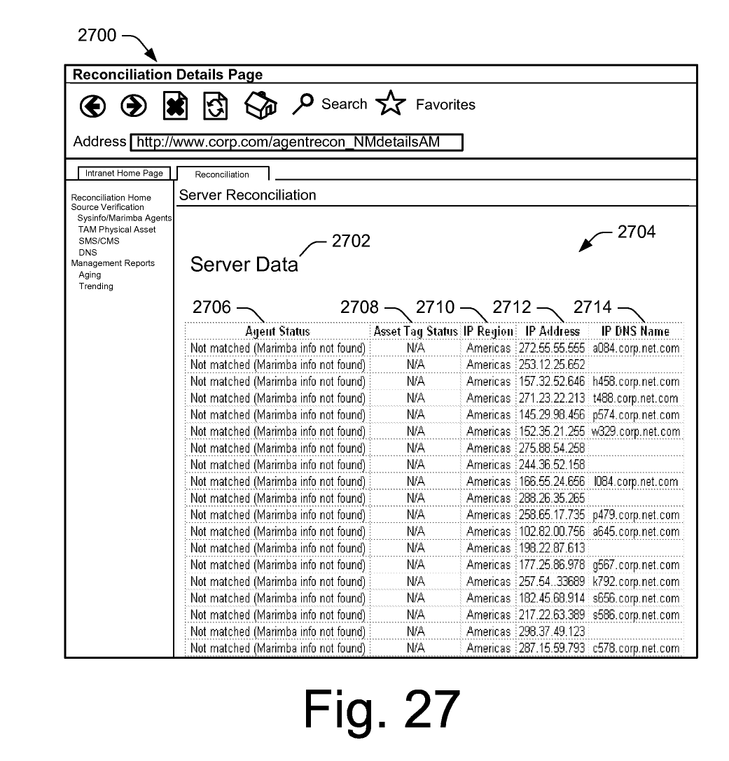

FIGS. 26-27 are renderings of example pages that provide additional details of the reconciliation information reported by the reconciliation pages of FIGS. 24 and 25.

### DETAILED DESCRIPTION

This disclosure is directed to techniques for constructing, maintaining, managing, and reconciling an inventory of hardware, software, and telecommunications assets distributed throughout an organization. The inventory may also identify applications, which are logical sets of resources including computing devices, software programs, and/or telecommunications devices that perform a specific business function. The techniques include a streamlined process for developers and managers to register applications through use of automated discovery processes for servers and locations. Also, various forms of inventory management and reporting of applications and deployments are supported. Data integrity is ensured and managed through a reconciliation process.

As a result, the inventory is kept accurate and up to date. This provides a robust information source for many different planning purposes. For instance, with such an inventory, authorized personnel can ascertain at any given time what assets are available where. In an event that a disruption impacts performance at a specific location (e.g., natural disaster, terrorist attack, etc.), members of the business continuity planning (BCP) team can quickly determine what assets are impacted and rebuild that capability at another location.

For discussion purposes, the techniques will be described in the context of an exemplary environment shown in FIG. 1. However, the techniques may be used in other environments, and be implemented using different architectures than those shown in the exemplary environment discussed below.

Exemplary Environment

FIG. 1 illustrates an exemplary environment 100 in which an architecture for building, maintaining, managing, and reconciling an inventory of hardware, software, and telecommunications assets distributed throughout an organization may be implemented. In the illustrated environment 100, the organization is a global organization with resources spread worldwide, as represented by various locations around a globe 102. The architecture enables the global organization to have knowledge of these distributed assets in the event portions of the organization experience unexpected events, such as natural disasters or human acts of terrorism, theft, arson, and so forth. Software assets include applications, each of which is a logical set of resources that perform a specific business function. The resources may include computing devices, software programs, telecommunications devices, and/or any other assets or processes that together perform the business function.

By maintaining a current inventory of hardware, software, and telecommunications assets, the architecture allows authorized personnel to find answers to many interesting and diverse questions. Of particular interest is the question of what technology is currently implemented at certain physical locations of the organization, and if something were to happen to that location, what is needed to rebuild its functionality.

To illustrate the usefulness of such an architecture, consider the environment 100 of FIG. 1 where a member of a business continuity planning (BCP) group resides in New York City. The BCP member uses a computing device 104 (e.g., a desktop PC, laptop, PDA, cell phone, etc.) to find out what hardware resources, software applications, or telecommunications devices exist at a facility in Hong Kong. The computing device 104 executes a browser or other program 108 to access remote servers over a network (not shown) to access the inventory of hardware, software, and telecommunications assets and ascertain which are located in the facility in Hong Kong. Although not shown, the network might be any number or combination of different networks, including proprietary data networks, the Internet, wireless networks, satellite networks, and the like.

Among the remote servers are one or more application directory servers 110(1), . . . , 110(M) that may reside, for example, in a different location (e.g., London). The remote servers may also include one or more global inventory warehouse (GIW) servers 112(1), . . . , 112(N) that may reside in still another location (e.g., San Francisco). It is noted that these locations are merely illustrative, as the servers may be co-located at the same location or located in any number of places throughout the world. Furthermore, these servers may be implemented in any number of ways, including as networked servers (perhaps arranged as a server farm), a mainframe computer, or other types of computerized systems.

An application directory program 120 is installed and executed on the servers 110(1)-(M). The application directory 120 maintains an inventory of applications deployed through the organization. The application directory 120 also provides a streamlined process for developers and managers to register applications through use of automated discovery processes that systematically gather various types of data about the applications, such as servers, locations, deployment details, and so on. The application directory 120 is described below in more detail with reference to FIGS. 5-12.

A global inventory warehouse (GIW) 122 includes a GIW database 142 and is serviced by the GIW servers 112(1)-(N). The GIW 122 serves as a repository of data feeds from reconciliation and authoritative sources for the purposes of building a consolidated inventory of the organization's hardware, software, and telecommunications assets. The GIW 122 receives data from many different sources and maintains a history of the data. Further, the GIW 122 supports reporting of the information in many different views and formats. It is further noted that although the GIW 122 is shown as residing in one location (e.g., San Francisco), the GIW 122 may be distributed over multiple geographic locations and/or replicated in multiple different places to protect against single site failures.

The application directory 120 is one of the data sources for the GIW 122. When a developer registers a new application using the application directory 120, that information is first stored in an inventory database maintained by the application directory 120 and then fed to the GIW 122 for storage and organization. Authorized users (e.g., BCP members, developers, managers, etc.) can access the information in application directory 120 and GIW 122 anytime using a Web-based tool, such as the browser 108. FIGS. 13-14 and their corresponding text describe the GIW 122 in more detail.

Continuing with our earlier scenario, suppose a user in the organization's New York office wants to know what technology is on the 36^{th} floor of a building in Hong Kong. In FIG. 1, the organization's facility in Hong Kong is represented by a building 124. A portion of the 36^{th} floor is shown as a collection of cubicle workspaces 126. Using computing device 104, the user can submit a request via a browser 108 for a listing of all technology housed on the 36^{th} floor of building 124 in Hong Kong.

FIG. 2 shows an exemplary user interface (UI) 200 rendered on the browser 108 to facilitate a search of applications in the application inventory. In this example, the user may enter different search criteria into a search pane 202 selected by an “enter filter criteria” tab 204. The search criteria may be predefined or responsive to keyword strings entered by the user. In FIG. 2, the search pane 202 provides multiple predefined search criteria, with some predetermined values made available in pull down menus. Among the search criteria are a tier 206 that defines the criticality of the application, a location 208 at which the technology is deployed, a division 210 that uses the technology, a category 212 to which the application belongs, and an owner 214 who is responsible for the business area, development, or operations related to an application. In this particular example, the user in interested in technology in Hong Kong, so she selects Hong Kong for the location search criterion 208. Once the user selects the appropriate criteria, she may click or otherwise actuate the “Find” button 216 to submit a search query to the application directory 120 (or GIW 122).

In some implementations, the UI may facilitate entry of additional information to provide varying levels of granularity in the search. For instance, in response to the user entering the location “Hong Kong”, the UI might return another pane seeking further selection criteria, such as a listing of possible buildings in Hong Kong, the floors in those buildings leased by the organizations, and even workspaces on the floors. It is further noted that other UI techniques may be employed to facilitate entry of criteria for the search request. For instance, the UI might allow the user to enter keyword phrases of one or more keywords (e.g., “Hong Kong computer software), or type in queries in the form of questions (e.g., “What software is installed on the computers in Hong Kong?”).

With reference again to FIG. 1, the application directory servers 110(1)-110(M) receive the request from the computing device 104 and search the directory 120 for the requested information. Once found, the servers 110 format and serve the data to the user's computing device 104 in the form of a webpage report arranged, for example, in terms of hard resources (e.g., computers, keyboards, monitors, computers, network connections, etc.) and soft resources (e.g., applications, drivers, etc.). Of course, the GIW servers 112(1)-(N) may also receive this request and search the GIW 122 for the requested information.

By submitting different search requests, the user may either expand or narrow the search. For instance, the user may ask for a more expansive report of all technology in whole building 124 in Hong Kong. Conversely, the user may drill down farther and ask for information pertaining to a specific cubicle or workspace 128, such as workspace 36-22 (i.e., the 22^{nd} workspace on the 36^{th} floor) shown in FIG. 1. Continuing this latter example, suppose the target workspace includes a desktop computer 130 having a processor 132, a memory 134, and application programs 136(1), . . . , 136(K) stored in the memory. Thus, a report returned to the requesting user computing device 104 in response to a request for technology residing in workspace 36-22 might include a listing of the computer 130 (e.g., box, monitor, keyboard, mouse, etc.), processor 132, memory 134, and application programs 136(1), . . . , 136(K). These results may be presented in any configurable format.

FIG. 3 shows a rendering of an exemplary UI 300 with a listing of applications returned from the submitted search criteria. A results pane 302 selected by a “search results” tab 304 shows the various applications located in the search. In this example, in response to location parameter of “Hong Kong”, a listing 306 shows those applications deployed in Hong Kong, including applications ABC and XYZ. The listing 306 may be formatted in any number of ways. Here, the listing 306 includes a tier 308, a name 310 of the technology, a unique application identifier (AID) 312, a division 314 and a location 316 in which the technology is deployed, and an owner 318 of the technology. Notice that each of the applications is in a location 316 of “Hong Kong”.

With reference again to FIG. 1, the architecture shown in environment 100 facilitates this knowledge of where resources are located and who is responsible for them by collecting and maintaining an accurate, up-to-date inventory of applications and corresponding assets. Several tools are provided to ensure reliable collection of such information when the resources are deployed.

One tool to gather information on new applications is a series of interfaces served by the application directory 120 to automate and standardize registration of newly installed applications. For instance, suppose a new application is being installed in Hong Kong, and as part of the application, a software program 140 is installed on computer 130. As part of this installation process, a responsible user (e.g., IT personnel, business owner, computer user, etc.) is tasked with registering the new application. The application directory 120 serves a series of web pages designed to gather information from the user regarding the application name, location, division, business owner, and so forth. The information entered by the user is routed over the network and stored in the application directory 120. From there, the same information (or portions of it) can be fed to the GIW servers 112 for storage in the GIW database 142.

This process is repeated each time an application is installed, upgraded, removed, or replaced on any computing system throughout the organization. Also, similar processes may be employed for hard assets, such as computers, printers, network devices, and so forth. In this manner, the GIW 122 (and more particularly its database 142) maintains an accurate and current inventory of resources distributed throughout the organization. A more detailed discussion of collecting and maintaining this inventory is described below with reference to FIG. 4.

The ability to ascertain what resources are available where, at any given time, is beneficial for many reasons. One benefit is that knowledge of which technologies are deployed at what locations enables improved business continuity in the event of natural or human-instigated disaster. For instance, suppose a natural disaster hits Hong Kong (e.g., a tsunami, monsoon, earthquake, etc.), causing damage to a bond trading operation in Hong Kong (FIG. 1). A member of the BCP group sitting in New York would be able to quickly determine what assets have been adversely impacted and what functionality is missing. The BCP member may then reconstruct the lost resources in another location to bring the bond trading functionality back on line quickly.

Another benefit is that having an up-to-date inventory of technology assets allows for regular and timely upgrades. The architecture maintains an accurate accounting of all computers, their location, all software that is running on those computers, and the business owners that are being supported. When upgrades are scheduled to be deployed, a member of the organization's IT department can schedule the assets at various locations for software and hardware upgrades while providing sufficient time for the business owners to plan for service to be temporarily down, or to have additional resources available during the upgrade. Additionally, the IT department is able to manage asset lifecycles to timely replace certain computers and devices upon reaching an appropriate age.

An accurate inventory of computers and applications also facilitates space planning when people or departments are physically moved from one location to another. The moving team can be given a map of what resources are to be moved and re-installed at the new location. Furthermore, an accurate inventory allows the organization to more effectively monitor the security of its hardware and software assets. Such assets may also be tracked by appropriate business owners for such internal accounting as charge-backs, allocations, and provisioning and de-provisioning of assets.

Still another benefit of an accurate and up-to-date inventory is that the organization may adhere to certain deployment initiatives as well as comply with licensing agreements and support potential license negotiations.

Architecture

FIG. 4 shows an exemplary architecture 400 that may be implemented in the environment 100. The architecture 400 has several functional groups that together carry out the functions of inventory gathering, management, reconciliation, and reporting. The functional groups include workflow processes and automated computerized systems. In the illustrated implementation, there are seven groups: inventory and reconciliation systems 402, workflow processes 404, systems with managed data 406, discovery tools 408, systems receiving GIW data feeds 410, online applications 412, and reporting tools 414.

The inventory and reconciliation group 402 includes the global inventory warehouse (GIW) 122 and a reconciliation framework 420. The GIW 122 includes the GIW database 142 and is a repository of data collected from reconciliation and authoritative sources for purposes of building a consolidated inventory of hardware, software, and telecommunications assets. The GIW may also contain other information, such as exception information generated in response to one or more reconciliation processes.

The GIW 122 receives data feeds from the managed data systems 406 and the discovery tools 408 as represented by data flow arrows 422 and 424, respectively. The GIW 122 stores and organizes the data in various data structures and formats such that selections of the data may then be fed or produced on request to other systems, applications, and tools. As shown in FIG. 4, the GIW 122 provides data feeds to a collection of systems grouped under the GIW data feeds group 410, as represented by data flow arrow 426. The GIW 122 also provides replies to on-demand requests to a set of online applications 412 and to various reporting tools 414, as represented by data flow arrows 428 and 429, respectively.

Data is fed into the GIW 122 from the managed data systems 406. The managed data systems 406 include multiple data systems 474(1), . . . , 474(P), which capture data that is entered and managed by people according to workflow processes 404. The data in such systems does not lend itself to automatic discovery tools, such as tools 408 discussed below. Rather, the data might include information that managers enter, such as physical location, cabinet that the router sits in, and so forth. The data systems 474(1)-474(P) are representative of many possible data systems including, for example:
Active Directory™—a system that contains distribution lists and Windows™ Machine Mappings
Cable Management Systems (CMS)—a system that contains locations (e.g., a cabinet location) of distributed assets
Confucius—a system that contains data from strategy-based Linux™ servers
DeviceDB—a system that contains a managed inventory of Network Hardware Devices
Configs—a system that contains database configuration information
TAM—a system that contains technology assets and their locations
Terminal Servers—a system that contains data about terminal servers
DevForge—a system that contains information about application-development projects
Device Modeling—a system that contains attributes (e.g., lifecycle) of hardware and operating system assets
Domain Name System (DNS)—a system that contains domain name information for distributed assets
Ivize™—a system that contains voicemail distribution lists
LifeLine™—a system that contains contact lists
Corporate Directory—a system that contains personnel data for employees of the organization
Controller—a system that contains information (e.g., dept. codes, dept. open/close dates) about organizational departments
SMART—a system that contains organization hierarchy
SPARC™—a system that contains department redirects
Technology Financial Services—a system that contains business unit mappings throughout an organization to facilitate reporting
GSLocation—a system that facilitates data discovery on valid buildings, floors, rooms, and desk locations

Another managed data system is the application directory 120 (also represented as data system 474(1) in FIG. 4). The application directory 120 serves in the architecture 400 as the authoritative inventory of applications deployed throughout the organization. The application directory 120 maintains the inventory in a repository or database 430. The database 430 organizes information relevant to the applications, such as criticality tier, unique identifier, business owner, division, location, and so on. As the authoritative system, the application directory database 430 is considered to be the most accurate and up-to-date collection of information on the applications. One exemplary implementation of the application directory 120 is described below in more detail with reference to FIG. 5.

Through individual data systems 474(1)-474(P), the managed data systems 406 provide a great deal of data to the GIW 122. For instance, the application directory 120 provides data on software applications to the GIW 122. Furthermore, the data in the managed data systems 406 is received from any number of sources. One source is, for example, application developers 432, who register applications with the directory 120 as part of various workflow procedures when the applications are installed or otherwise deployed. Another source is an inventory control group 434, which has management authority over the inventory maintained in the application directory database 430. The registration processes are streamlined for developers and managers to register applications with minimal manual intervention. Other data sources may exist for each individual data system 474(1)-474(P).

A third source for application-related information is the reconciliation framework 420, which updates the application directory through a validation and reconciliation process on the data maintained in the GIW 122. Reconciliation processes attempt to automate handling of data validation exceptions, and feeds the reconciled information to the managed data systems 406, such as the application directory 120, as well as back to the GIW 122. Data integrity is ensured and managed through these reconciliation processes which may in part populate the managed data systems 406 (e.g., application directory) data from the global inventory warehouse 122 feeds from the multiple discovery tools 408. These reconciliation processes are described in further detail with reference to FIGS. 16-27.

Table 1 shows an example, and non-exhaustive, list of possible data feeds into and out of the application directory 120, one of the managed data systems.

TABLE 1

| | | Feed |
|---|---|---|
| | | Direc- |
| System | Data | tion |
| Business | Application directory data to BCP system. | OUT |
| Continuity | | |
| Planning | | |
| Authorization | Authorized user data. If application user | IN/ |
| | | OUT |
| Monitoring | changes division or leaves organization, | |
| Project | application managers are notified to change | |
| | application access accordingly. | |
| Marimba | Windows ™ servers and installed software | IN |
| Sysinfo | Unix ™ servers and installed software | IN |
| Red Hat | Package information on Linux ™ servers | IN |
| Network | | |
| Switch | Server availability and location detection | IN |
| Management | | |
| DBDB | Database of databases (Sybase, SqlServer, | IN |
| | UDB) | |
| SONAR | Server availability and location detection (base | IN |
| | system for all servers). | |
| TAM | Hardware Asset Inventory. Contains the | IN |
| | location and asset tags for all desktops, | |
| | servers, printer, routers and switches. | |
| LifeLine | Lists for support of jobs related to applications | IN |
| | and servers. | |
| Corporate | Contact information for deployment managers | IN |
| Directory | Application Directory stores IDs (e.g., | |
| | Kerberos, GUIDs, etc.) | |
| SMART/ | Divisional Hierarchy for Portfolio Reporting | IN |
| OrgBud | | |

Other feeds that may be passed into the application directory 120 include data from a system that monitors processes and servers (e.g., HP OpenView™ system) and data from risk reporting systems.

Discovery tools 408 also provide data feeds to the GIW 122. The discovery tools 408 include multiple tools 440(1), 440(2), . . . , 440(J), which go out periodically or routinely (e.g., nightly) to gather data from the components themselves. The data is such that lends itself to automated collection without human intervention, and may involve such things as operating conditions, workload, failures, and so forth. The tools 440(1)-440(J) are representative of many possible automated data collection tools including, for example:
Confucius—a tool that provides strategy-based data from Linux™ Servers
EMC™ Enterprise Control Center (ECC)—a tool that provides a raw storage area network inventory
Marimba™—also known as Marimba Inventory—an agent used to deploy and report on packaged applications to Windows™ PCs.
Red Hat™ Network—an agent that runs on Linux™ and deploys packaged applications to Linux™-based servers.
SONAR—an agent that provides IP address discovery
Switch Management System (SMS)—a tool that provides server availability, location detection (e.g., host connections and locations), and network information (e.g., information about network routers and switches)
Sysinfo—an agent that runs and reports on Unix™ configurations and variants
Storage Information—a tool that provides inventory of storage area network (SAN) arrays, switches, and servers
Production Access Reporting (PAR)—a tool that provides for production access reporting
TRACER—a tool that manages and provides data reconciliation and grading services
ProWatch™—a tool that provides data about data center access logs

The GIW 122 provides data feeds to a variety of systems represented in group 410. Among these systems are Server Central 450, Security Monitoring 452, Database Administration 454, Market Data Administration 456, Business Continuity Planning 458, and System Administration (SA) Tools 460. The Server Central 450 is a web application that presents server inventory information from the system administrator perspective, including performance metrics information. The Security Monitoring system 452 is responsible for identification, engineering, and operation of solutions to monitor the security of the organization's infrastructure as well as the staff and vendors use of the systems. The Database Administration system 454 is responsible for management of various databases used throughout the organization. The Market Data Administration system 456 manages an inventory of internally and client-consumed market data. The Business Continuity Planning system 458 supports many continuity solutions including crisis management, business recovery, systems and data recovery, people recovery facilities, and process improvement. The SA tools 460 are a set of tools for monitoring operation of systems from a software and hardware perspective, such as performance metrics, usage, and the like.

Online applications 412 represent another set of data consumers from the GIW 122. The online applications include the Server Central 450, the SA tools 460 and the Application Directory 120. Each of these may be implemented as Web-based tools that can query the GIW 122 for specific information. Additionally, reporting tools 414 may submit queries to the GIW 122 to generate various reports on applications deployed throughout the organization. These reporting tools 414 might include, for example, Inventory Reporting 470 and Business Continuity Planning (BCP) reporting 472.

The illustrated data providers and data consumers of the information maintained in the global inventory warehouse 122 are representative. There may be any number and variety of data providers and data consumers. Moreover, the data providers and consumers may be off-the-shelf products or custom-built components designed specifically for the architecture or for particular functions. A section entitled “Global Inventory Warehouse” follows a discussion of the application directory 120 and an accompanying registration process, and describes components of the GIW 122 in detail.

Application Directory

FIG. 5 shows one example implementation of an application directory 120 executing on one or more servers 110 (FIG. 1). The servers 110 are equipped with processing units 502 and memory 504 (e.g., volatile, non-volatile, and persistent memory). A network interface 506 provides access to and communication over a network (e.g., LAN, Internet, wireless, etc.).

The application directory 120 is shown stored in memory 504, but is executed on processing units 502 during runtime. Selected components in the application directory 120 include a repository or database 430, an application registration module 510, and an application portfolio module 512. As noted above, the application directory database 430 maintains an inventory of applications deployed throughout the organization. The application registration module 510 and the application portfolio module 512 provide Web-based tools for automated registration of applications and management of the application portfolio.

More particularly, the application registration module 510 facilitates automated registration of the applications and provides the mechanism for getting them approved for deployment. The module 510 includes a user interface (UI) 514 that guides developers and managers (and others) through the initial registration process, as well as any updates to application data in the application directory 120 and its associated checkpoints and reconciliation systems. Additionally, the application registration module 510 allows managers to approve new applications and deployments for submission to the business continuity planning (BCP) team. The BCP team can then review and approve deployment requests using the application registration module 510. An example set of UIs for the registration process is provided below in more detail with reference to FIGS. 6-11.

The application portfolio module 512 provides the online tool for managers to generate Web-based reports against the GIW data feeds of application directory data. The data feeds may be frequent (e.g., every day, every hour, etc.), or as updated, or as needed. With this module 512, a manager may generate reports that sort or format applications by various criteria, such as by division, location, tier, category, status, and so forth. The application portfolio module 512 has a portfolio UI 516 that provides interfaces for a user to enter search criteria and presents results of the search. Two exemplary UI interfaces are shown in FIGS. 2 and 3, as described above in detail. In FIG. 2, an application portfolio UI 200 facilitates user entry of various search criteria for applications distributed throughout the organization. The interface 300 shown in FIG. 3 presents a list of all applications that satisfy the search criteria. In addition, the portfolio UI 516 aids in the management of families of applications, and allows users to define groups within individual families.

There are several possible parties who may interact with the application directory 120. Developers (e.g., firm users, code developers, support engineers), development manager (e.g., mid-level development managers responsible for support and deployment of applications), members of the business continuity planning group, and regulatory auditors are among the different classes of users who may use the application directory 120.

The application directory 120 further includes a repository or database 430 to store the applications in an organized inventory 518. The inventory 518 is composed of records 519 that store data pertaining to the applications deployed throughout the organization. Each record 519 arranges data according to a hierarchical logical data model 520 that defines multiple levels of data types and relationships amongst those levels. The hierarchical data model 520 includes a top or family level 522, a second or application level 524, a third or deployment level 526, and a fourth or component level 528.

As noted earlier, an application is a logical entity, made up of components that perform a specific business function. A family defined at the first level 522 of the data hierarchy 520 is a collection of one or more applications in the second level 524 that either perform a set of related business functions or have a common IT support structure. Each application may have one or more deployments in the third level 526. A deployment is an instance of an application that runs in a specific location. And each deployment may involve one or more components in the fourth level 528. A component is a piece of an application that shows up as an individual system process or as an individual deployable unit. It is noted that this data hierarchy 520 exemplifies just one example arrangement of a data structure. Other hierarchical models of more or fewer levels may be employed.

FIG. 6 shows an example home page 600 for the application directory 120. This home page 600 functions as an entry portal to the registration UI 514 and the portfolio UI 514. The home page 600 includes multiple tabbed panes including a tab 602 for access to the organization's intranet home page and a tab 604 for access to a primary pane 606 of the application directory. On this primary pane 606 are a navigation menu 608, a greeting 610 to the authorized user, a statistics area 612, a news area 614, and a task area 616.

The navigation menu 608 provides a set of links to various processes, such as registration, record modification, and reporting. To register an application, a user may access a sequence of web pages by selecting the link “Register Application” on the menu 608. Similarly, a user may generate a report of applications stored in the application directory database by choosing the “Portfolio Reports” link or one of the criteria links (e.g., “By Tier”, “By Location”, etc.) in menu 608.

The statistics area 612 provides a summary of the total applications, deployments and components registered. The news area 614 provides notice of any system alerts, such as enhancements, bug fixes, updates, maintenance down time, and so forth. The task area 616 provides a running list of applications to be acted upon by the user, based on that user's role. The list includes active links to an application management page that allows the user to act on the application. The link is represented by underlining in FIG. 6, although other expressions may be used such as font change, color differentiation, and so on.

The task list in area 616 further includes a status designation 618 of each open task. Table 2 provides a listing of possible statuses:

TABLE 2

| Status | Definition | Next Status |
|---|---|---|
| DRAFT | Developer is drafting a new or revision of | OPEN |
| | application/deployment and has not yet | |
| | submitted it to a developer manager for | |
| | approval. | |
| OPEN | Developer manager is reviewing new or | PENDING or |
| | revision of application/deployment and has not | REJECTED |
| | yet submitted to BCP for approval. | |
| PENDING | Developer manager has submitted application | ACTIVE or |
| | for BCP approval. | REJECTED |
| REJECTED | BCP or development manager has rejected | DRAFT |
| | application data, status is reverted to | |
| | “DRAFT” for developer to review and update | |
| | data for application and resubmit for | |
| | developer manager and BCP approval. | |
| ACTIVE | BCP has reviewed application data and | NA |
| | approved application for deployment. | |
| EXCEPTION | Reconciliation with GIW feeds has shown | If data is |
| | discrepancies and applications are flagged as | reviewed, |
| | “EXCEPTION”. | corrected and |
| | Application data is flagged as out of date if | discrepancies |
| | application has not been reviewed by | are cleared, will |
| | development team in a specified amount of | go to DRAFT |
| | time. | state. |
| DECOMMISSION | Legacy server or application no longer in use | N/A |
| REPLACED | Legacy application has been replaced by new | N/A |
| | application. Reference new application | |
| | identifier for replacement application. | |
| INACTIVE | Legacy status - Used on inactive applications | NA |
| | for historical purposes | |

Now, suppose a user would like to register a new application. The user may actuate the “Register Application” link in the menu 608. That would lead him to a series of screens to enter data about the application.

FIG. 7 shows a first registration page 700 that is initially served by the application directory 120 when a user seeks to register a new application. The registration page 700 includes a pane 702 that systematically guides the user through a series of questions about the application. The registrant enters a name for the application in entry field 704. The name may conform to standardized naming conventions, and its size may be constrained to some maximum number of characters. A BCP architecture pull down menu 706 allows the user to select a general architecture of the application, including such choices as mainframe, distributed, and mid-range.

A contact list for the application may be selected by pull down menu 708. This contact list identifies which business organizations (divisions) are primary clients of this application. In response to selection, a table of responsible owners will be automatically populated with appropriate names. A brief description of the primary business function performed by the application may be entered into field 710. Such a description may be limited to a number of words (e.g. 500 words).

The registrant selects an appropriate application family for this application using pull down menu 712. A set of predefined family names are provided in this menu, enabling the registrant to quickly find which family is the best fit for the application. A version number for the application may be entered into field 714, and a document URL (universal resource locator) may be added in field 716. Any additional comments may be entered into text field 718.

Some applications may be governed by various government (federal, state, and city) regulations. For instance, applications related to financial transactions may be governed by SEC rules, federal laws, state regulations, and so forth. In field 720, the registrant may be presented with a list of possible regulation categories that might be applied to the application. The registrant can select suitable categories and the application is marked for compliance with the selected categories.

Notice also in the left margin beneath the menu 608 is a small icon 722 that provides a visual cue of the hierarchical logical data model 520. The model conveys to the registrant how data is being organized within the logical data model. A focus is also provided to illustrate which data is currently being sought from the registrant as he proceeds through the series of web pages. In this illustration, the upper two levels—family level 1 and application level 2—are in focus to visually convey that this portion of the registration concerns higher level information pertaining to the application and its family. The focus may be accomplished by changing the color of the upper two levels, or by highlighting them, or by enlarging them, or through some other graphical technique. As the registration process continues, different levels of the icon 722 will be placed in focus to assist the registrant.

FIG. 8 shows a second registration page 800 that continues the registration process. Notice that the focus in the hierarchy icon 722 has now shifted to the deployment level 3 to visually inform the registrant that this web page concerns entry of deployment information. Additional focus is on an “owner” box at the bottom of icon 722 to impart that this page 800 contains entry fields for identifying the owner of the application.

A pane 802 guides the user through a series of questions to extract deployment details. In field 804, the user enters a location (e.g., “New York”) at which the application will be deployed. This location may be of any configurable granularity appropriate for the implementation, and may include floor, building, city, region, state, country, and so forth. A deployment name may be entered in field 806, and a unique application identifier (AID) 808 is automatically generated when a deployment is registered.

A tier is assigned at pull down menu 810. The tier provides a criticality rating of the deployment and ranges, for example, from 1 of low criticality to a 4 of high criticality. A next schedule test date may be entered into field 812 (or selected using a calendaring tool). These dates may include failover testing, live user testing, and the like. More than one type of test may also be scheduled by adding additional options in pane 802. The deployment manager responsible for the deployment from a technical and BCP perspective is selected in field 814. The individual chosen may be given responsibility to approve the deployment before it goes to the BCP group. One or more ROTAs may be added or removed using field 816. A collection of ROTAs (short for rotary) forms a list of contacts and preferred order and method (cell/page/call) of notifying those contacts in case an application problem occurs. It is used as reference data in the application directory, an alternate way of specifying the application deployment's contacts. Finally, a registrant may click an “Add Server” button 818 to choose servers utilized by this deployment. This action will open a new window to facilitate searching and addition of servers. The selected servers are then listed in table 820, which includes such information as a server asset tag, hostname, location, make/model, and platform.

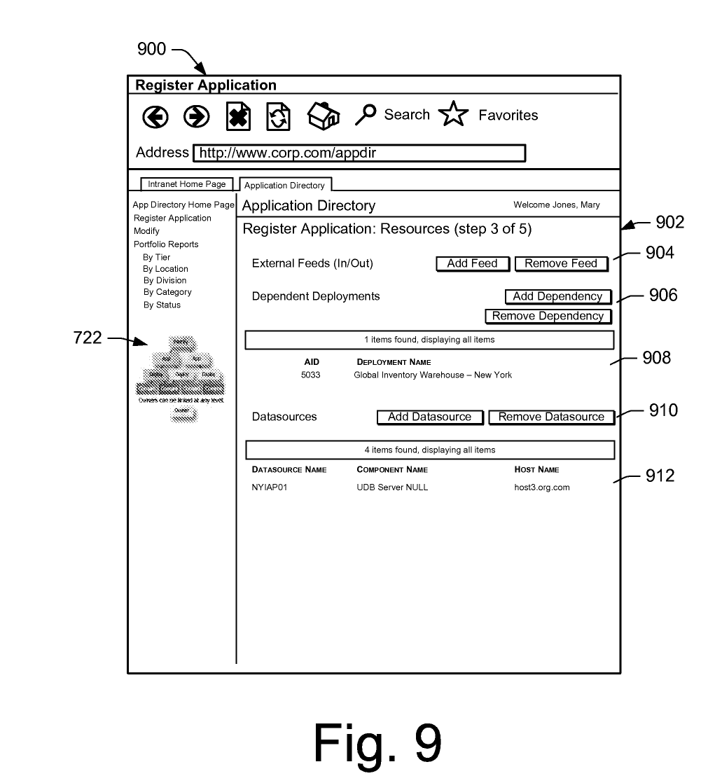

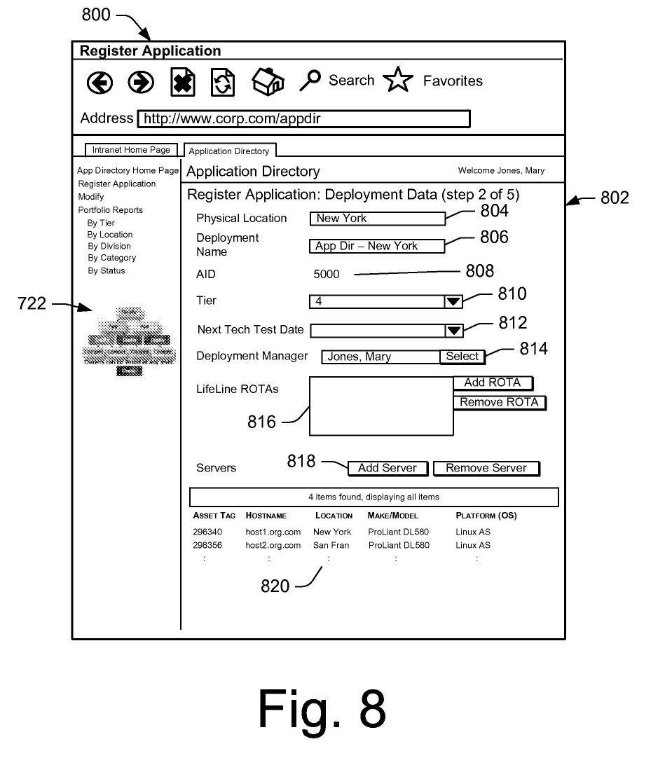

FIG. 9 shows a third registration page 900 that directs a registrant through the third step of the registration process. On this page 900, the focus of hierarchy icon 722 has shifted down to the component level 4 to visually convey that this page pertains to input of component information. A pane 902 guides the user through a series of entries regarding component information. In pane 902, the registrant may identify external data feeds in entry area 904 by clicking an “Add Feed” button to choose external feeds utilized by the application. This action will open a window that allows the user to search and add feeds. These feeds will then be depicted in a table (not shown). The user may subsequently remove feeds by actuating the “Remove Feed” button.

In entry area 906, the registrant may add any other deployments and internal feeds upon which the application is dependent. By clicking an “Add Dependency” button, a window is presented to facilitate search of dependent deployments. These deployments are listed in a dependent deployments information table 908. Any dependent deployment may be removed from the table 908 through use of the “Remove Dependency” button.

Data sources are also identified in entry area 910. Data sources include database instances and the components that run them. Actuating an “Add Datasource” button causes a window to open for searching and adding data sources to a data source information table 912. If a data source is on a server not currently associated with the deployment, selecting the data source effectively adds the server to the deployment. A “Remove Datasource” button is also provided to remove items from the table 912.

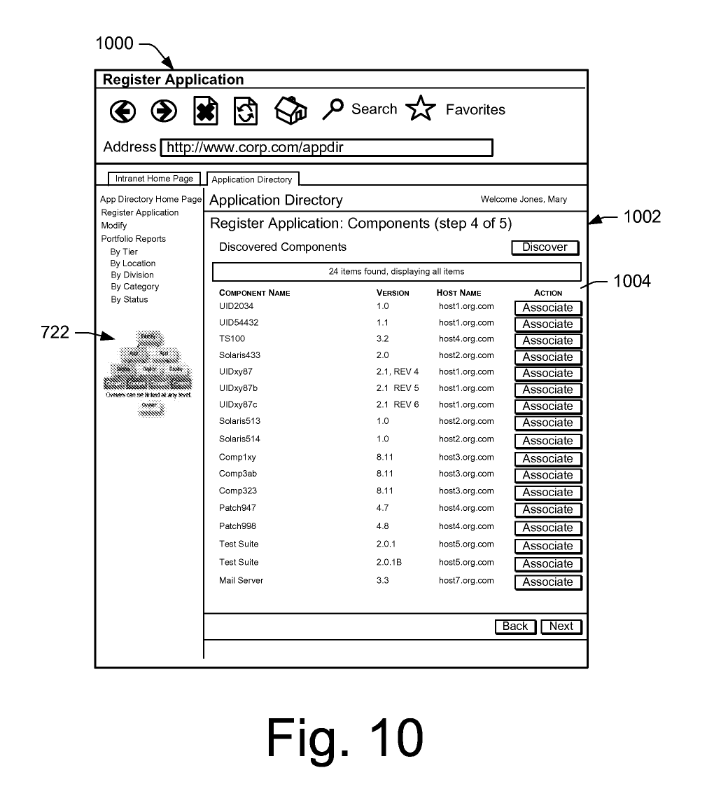

FIG. 10 shows a fourth registration page 1000 that continues entry of component detail in level 4, as noted by the visual hierarchy icon 722. A pane 1002 assists the user in discovering components relevant to the application being registered. When a user initiates the discovery process (e.g., by clicking the “Discover” button), a search query is sent to the global inventory warehouse (GIW) to return all components associated with the current deployment. These components include servers and other devices that implement the application. Components found by the search are returned and listed in a discovered components table 1004. The registrant may associate the component with the deployment by clicking an “Associate” button provided for each listed component.

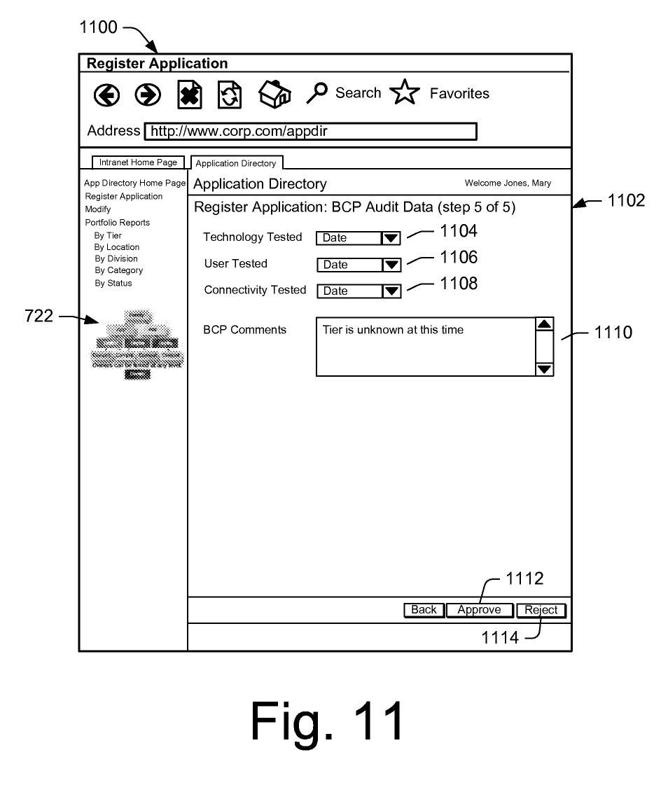

FIG. 11 shows a fifth and final registration page 1100 that facilitates entry of BCP audit date in the fifth and final step in the registration process. The BCP audit date pertains to the deployment level of detail and hence, the deployment level 3 is in focus once again on the visual hierarchy icon 722. A pane 1102 guides the registrant through details of an audit for purposes of business continuity planning.

At fields 1104-1108, the user can enter dates for when the technology was tested, when user testing was completed, and when connectivity testing was conducted. Any comments relating to the BCP audit may also be provided in text entry field 1110, including such comments on the rational behind a criticality rating assigned to the application. Also via this pane 1102, the deployment of this application may be approved (by clicking the “Approve” button 1112) or rejected (by clicking the “Reject” button 1114). If approved, the application status is changed to “Active” (See Table 2 above). Conversely, if rejected, the application status is returned to “Draft” status, and the developer at this point should review the application and registration, updating all data for application deployment, and then resubmit for approval.

Registration Processes

FIG. 12 illustrates a computerized process for registering applications or other assets of the organization. This process (as well as other processes discussed herein) is illustrated as a collection of blocks in a logical flow graph, which represents a sequence of operations that can be implemented, in whole or in part, in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The sequence in which the operations are described is not intended to be construed as a limitation, and any number of the described blocks can be combined and/or rearranged in other sequences to implement the process.

For discussion purposes, the process 1200 is described with reference to the architecture, systems, and UIs of FIGS. 1-11. It is noted, however, that the processes may be implemented in many other ways.

FIG. 12 shows a computerized registration process 1200. At 1202, a user interface is presented to facilitate entry of information pertaining to an application. In one implementation, this user interface is embodied as a Web-based data entry tool that may be rendered in a browser. Accordingly, in this implementation, the first act 1202 of facilitating entry of information may consist of three actions 1202(1)-1202(3). At 1202(1), the tool presents a series of web pages that guide the user through the registration process, collecting information about the application. One example series of web pages are described above and shown in FIGS. 6-11. These web pages are served by the application directory 120 and rendered by a browser or other rendering program.

The web pages seek entry of different types of information about the applications. The different types of information conform to the logical data model 520, which defines multiple hierarchical levels of data types and relationships amongst the hierarchical levels. At 1202(2), a visual cue representing the logical data model is depicted on the web pages to convey what data is currently being entered, and how that data is being organized in the inventory. One example visual icon is illustrated in FIGS. 7-11 as icon 722. Individual levels of the visual cue are placed in focus during the registration to aid the user during entry of the different data types to convey which data is being entered and how it is being organized within the logical data model. At 1202(3), the focus is changed within the visual cue of the logical data model in coordination with the data being collected by the web pages. As illustrated in the example of FIGS. 7-11, the focus is changed throughout the sequence of web pages.

At 1204, information pertaining to the various data types is collected during the registration process. Among the information collected are an application name, a family to which the application belongs, deployment data pertaining to deployment of the application, component data identifying components used by the application, and owner data identifying a business owner responsible for the application. Additionally, as exemplified in FIGS. 7-11, other information pertaining to the application may also be collected.

At 1206, the information is organized to form an inventory of applications. This inventory is maintained in the application directory database 430 (at 1208 in FIG. 12), and at least portions of the inventory are fed to the global inventory warehouse 122 (at 1210 in FIG. 12). In this manner, the application inventory may be viewed as being stored in two different databases—the application directory database 430 and the GIW database 142 (FIG. 1). The following section describes in detail the GIW 122 and its accompanying database 142.

Global Inventory Warehouse

FIG. 13 illustrates one example implementation of a global inventory warehouse (GIW) 122 executing on one or more servers 112 (FIG. 1). Similar to the servers 110 described above with reference to the application directory 120, the servers 112 are equipped with processing units 1302 and memory 1304 (e.g., volatile, non-volatile, and persistent memory). In addition, a network interface 1306 provides access to and communication over a network (e.g., LAN, Internet, wireless network, etc.), which allows authorized personnel to search the GIW database 142.

As discussed above, the GIW 122 is a repository of data collected from reconciliation and authoritative sources for purposes of building a consolidated inventory of hardware, software, and telecommunications assets. This data may include some or all of the information discussed above in regards to the application directory, such as an identification of the assets and the assets' physical locations. The GIW 122 may also contain exception information generated in response to one or more reconciliation processes. Furthermore, the GIW 122 maintains a history of the received data. The GIW 122 also supports reporting of the information in many different views and formats.

In addition to storing identifications of assets, physical locations of assets, and exception information, the GIW may also build relationships between assets in response to receiving data from the application directory 120. As discussed above, a user may register an application with the application directory and, in the process, register that application with a particular server upon which the application resides. When the application directory feeds this data to the GIW 122, the GIW then creates other relationships based on that data and based on additional information stored in the GIW. For instance, the GIW 122 may know that the particular server upon which the particular application resides is part of a particular network. The GIW 122 accordingly builds a relationship between the application, the server, and the particular network. Similarly, the GIW may create relationships between the application/server combination and a market data network, an Ethernet network, physical location information, tape backup location information, and the like. Furthermore, after creating these relationships, the GIW may provide these relationships back to the application directory 120. In turn, the application directory populates fields within the application directory user interface in order to allow for an application directory user to view these relationships.

FIG. 13 illustrates that the GIW 122 is stored in the memory 1304 of the one or more servers 112. Exemplary components in the GIW 122 include the GIW database 142, a receiver 1308, and a converter 1310. Selected components in the GIW database 142 include one or more source tables 1312, one or more staging tables 1314, and a refresher 1316.

The receiver 1308 receives data from some or all of the sources illustrated in FIG. 4, such as the managed data systems 406 and the discovery tools 408. The GIW 122 stores and organizes this received data in various data structures and formats. This storage and organization allows portions of the data to be fed or produced on request to other systems, applications, and tools. To so store, organize, and provide this data, the receiver 1308 initially receives a batch of raw data from the data sources. The receiver 1308 stores this batch as raw data records 1318.

The converter 1310 receives the raw data records 1318 and converts this raw data into “source” (src) data. FIG. 13 illustrates this converted data as src data records 1320. During the conversion, the converter 1310 computes a hash (e.g., MD5) of the raw data records 1318. This hash value creates an artificial primary key for each data record, which serves to uniquely identify each data record. By doing so, the converter 1310 allows the data to be annotated and indexed by its originating data source. This data conversion also includes converting source-system timestamps of the data into GIW-formatted timestamps.

After this conversion, the GIW database 142 receives the src data records 1320. Briefly, the one or more source tables 1312 are purged of any old data from a prior load, receive the new src data records, and then provide them to the one or more staging tables 1314. Authorized personnel can then search the staging tables and generate reports based on the information contained therein.

More specifically, the one or more source tables 1312 receive the src data records 1320 and build an inventory 1322 that contains this received batch of data records. FIG. 13 differentiates the data records within the source table inventory 1322 by representing them as SRC data records 1324. The inventory 1322 within the source tables 1312 generally provides the received batch of data records to the one or more staging tables 1314.

The staging tables 1314 thus receive the SRC data records 1324 and create an inventory 1326 that includes these records. At this point, the data records are designated as staging (STG) data records 1328. The staging table inventory 1326 operates to allow authorized personnel to search and generate desired reports from the data records therein.

By receiving batches of data records and providing each batch to the staging tables 1314, the source tables 1312 serve as a buffer between the source data systems and the staging tables 1314. This demarcation between tables thus helps to avoid introduction of invalid data from the source systems into the staging tables 1314. In turn, this demarcation helps to avoid introduction of invalid data into reports actually generated by the authorized personnel.

As stated above, the source tables 1312 generally receive batches of data records and provide these data records to the staging tables. Upon receiving a new batch of data records, the source tables 1312 generally delete the previous batch in order to make room for the new batch. Maintaining a batch of data records in the source tables until a new batch arrives allows administrators to perform debugging in the source tables if the administrators encounter problems with the data. The inventory 1326 within the staging tables, meanwhile, not only contains up-to-date and correct information, but also a history of that information. As such, the staging-table inventory 1326 generally does not delete data records, but rather tracks changes to the data as the changes occur.

To illustrate, the staging tables 1314 first receive the SRC data records 1324 from the source tables 1312 and, with the data, generate and maintain the inventory 1326. Again, this inventory 1326 includes STG data records 1328. As mentioned above, however, information pertaining to source systems will generally change with time. For instance, a location of a hardware asset may change. The inventory 1326 of STG data records should accordingly be updated to reflect these changes, while still maintaining a history of previous locations of the hardware asset. The refresher 1316 in conjunction with the SRC and STG data records updates the inventory 1326 in this manner.

The refresher 1316 may be configured to refresh STG data records 1328 when a change to a corresponding SRC data record 1324 occurs or, conversely, after a predefined amount of time. In the latter instances, the refresher 1316 initially compares the STG data records to corresponding SRC data records and counts a percentage of the former that should be refreshed. If this percentage is greater than a pre-configured threshold value, then the refresher 1316 aborts the refreshing process. If this percentage is less, however, then the refresher proceeds with the refreshing process.

The refresher 1316 first closes any open STG data records that don't correspond to an SRC data record in the source table inventory 1322. The refresher then refreshes the remaining STG data records with data from corresponding SRC data records. In some instances, the refresher matches corresponding records based on each record's hash value computed by the converter. The refresher may also match corresponding records by merely comparing the record values.

After matching corresponding SRC and STG data records, the refresher 1316 may utilize a technique known as “milestoning”. This technique begins by tagging each data record with a “start date” and an “end date”. The start date generally corresponds to when the data record was inserted into the inventory, while the end date generally corresponds to the time at which the data record should no longer be considered “live”, “current”, or “up-to-date”. If a record's end date has passed, then the refresher may know to update the data record. Of course, this milestoning technique is exemplary and other techniques may be utilized. For instance, in a “snapshot” technique, the refresher merely compares a previous snapshot of the staging table inventory 1326 to a current snapshot, and updates the inventory 1326 based on the difference.

In addition to updating existing records, the refresher 1316 creates a new STG data record for any SRC data record created since the last refreshing process. The refresher 1316 also inserts these new data records into the staging table inventory 1326. This refreshing process thus ensures that the staging table inventory 1326 contains the most up-to-date information. Importantly, the STG data records and the staging table inventory 1326 also maintain the information present in the inventory 1326 before the above-described refreshing process.

The inventory 1326 within the staging tables 1314 thus represents all or substantially all of the data received from the source systems. This consolidated inventory maintains a history of this data, even as it changes with time. For instance, any change to a location of a hardware, software, or telecommunications asset will be noted. Both locations, however, will be stored within the inventory 1326, thus facilitating the reporting of this history should authorized personnel desire such information.

As such, the resulting GIW database 142 allows for customized viewing of data corresponding to multiple source systems. Furthermore, this viewing may be customized at any level of granularity, including customizing authorized personnel's viewing of individual data fields within a single data record. Such a database allows these personnel to find data discrepancies within source systems by cross-referencing each system. The GIW database 142 also enables searching and reporting of historical data. Finally, note that the detailed information within STG data records 1328 enables the reporting of substantially all reasonably useful information pertaining to the source systems. This information not only includes physical locations of distributed assets, but also exception information created during one or more reconciliation processes.

FIG. 14 illustrates an exemplary process 1400 for receiving a data record from a source system and storing the record in the GIW database 142. Source system “Alpha” 1402, containing an exemplary batch of data records labeled “Set”, represents the exemplary source system. Data flow arrow 1404 represents the receiver 1308 first receiving the “Set” data records as raw data labeled “File Set-raw.txt”. The converter 1310 then receives and converts this batch of data records into src data labeled “File Set-src.txt”, as data flow arrow 1406 represents. Data flow arrow 1408 illustrates the converter 1310 then providing this data to the source table 1312 of the GIW database 142.

After receiving the batch of data records, the source table stores and entitles this batch as “T_SRC_Alpha_Set”. Any prior data in “T_SRC_Alpha_Set” is initially purged before storing this new batch of records. The first portion of the title (T_SRC) identifies the records as being stored within the source table 1312. The middle (Alpha) and latter (Set) portions, meanwhile, identify the batch of data records with its corresponding system and its initial batch name. The source table 1312 or the refresher 1316 then provides these data records to the staging table 1314, which stores the batch of data records as “T_STG_Alpha_Set”. Data flow arrow 1410 represents this operation. Again, the former portion of the “T_STG_Alph_Set” label identifies this batch of data records as being stored within the staging table 1314.

In accordance with this exemplary process 1400, the staging table inventory 1326 contains data records corresponding to the “Set” batch of files from the “Alpha” source system. Each batch of data records from each source system within an organization may likewise be included in this inventory, via process 1400 or the like. As such, the staging table inventory 1326 may contain an identification of all or substantially all of the organization's hardware, software, and telecommunications assets, as well an identification of physical locations of these assets. Again, this inventory may also include other information, such as exception information generated during one or more reconciliation processes.

Inventory Management Processes

FIG. 15 shows a process 1500 for managing and utilizing the application directory 120 and the GIW 122. The process 1500 is described with reference to the architecture, systems, and UIs of FIGS. 1-14 but may be implemented in many other ways. At 1502, an inventory of applications and other assets distributed throughout an organization is maintained. In part due to the registration process, the inventory is kept up-to-date and accurately reflects the current deployment of applications in the organization. Moreover, at 1504, operational data is collected from deployed applications on an ongoing basis. Such information may be supplied by software and hardware components, and may include such data as usage, load, failure conditions, aging, and so forth. In this manner, the inventory provides a robust and current knowledge source of all applications within the organization.

The inventory may be used effectively in many different ways. Three different scenarios are shown in FIG. 15, but these scenarios are merely illustrative and are not intended to be limiting. In one scenario, authorized personnel (e.g., IT department, BCP members, developers, etc.) may mine the inventory to learn what applications and other assets are deployed in the organization. Such personnel may employ a UI to define a search of the inventory for certain assets that meet the search criteria. One example UI is illustrated in FIG. 2, where the user permitted to search applications by tier (i.e., criticality), location, division, category, and owner. Many other search criteria may be employed.

At 1506, the search request is received and processed. Suppose, for example, the search personnel wants to know what assets are deployed on the 36^{th} floor of a building in Hong Kong, as represented in the environment 100 of FIG. 1. A search request may be defined with such granularity to find all such assets that are deployed at this physical location in Hong Kong. At 1508, the inventory is searched responsive to this request. The searching may be conducted on the application directory database 430, or alternatively on the GIW database 142.

At 1510, a listing of assets from the inventory that satisfy the search is presented. This listing may be presented in a UI, such as the one example shown in FIG. 3. Being able to call up all applications and other assets that meet a certain criteria is very useful in many ways. For instance, following a disruption at a particular location, the BCP team may wish identify all assets deployed in the particular location and rebuild the functionality elsewhere. As another example, space planners may need to move a department from one physical location to a new physical location. By mining the inventory to identify the assets affected by the move, the space planners can take steps to ensure the functionality is available elsewhere during this transition and minimize the time that the assets are down.

In another scenario shown in FIG. 15, authorized personnel using the reconciliation framework can reconcile records in the inventory with data from other sources in the architecture to ensure accuracy and data integrity in the inventory. Thus, at 1512, a reconciliation process may be performed on the inventory.

In still anther scenario shown in FIG. 15, different personnel may use the inventory to manage the applications and other assets at 1514. For instance, suppose the IT department wants to upgrade all applications in a systematic way. An IT team member may conduct a search for applications based on age or lifecycle criteria to identify which applications are suitable for upgrade or replacement. As another example, suppose the IT department wishes to evaluate the applications for usage and load. By maintaining an accurate and up-to-date inventory of applications, including usage and load, actions may be taken to anticipate and prevent potential problems such as application failure.

Data Reconciliation

With reference back to FIG. 4, the illustrated architecture 400 enables building, maintaining, managing, and reconciling an inventory of hardware, software, and telecommunications assets distributed throughout an organization. This inventory of hardware, software, and telecommunications assets allows authorized personnel to find desired answers to certain queries, including queries about assets' physical locations. As discussed above, the GIW 122 maintains this inventory as well as information about the inventory. Unfortunately, corresponding data pulled into the GIW 122 from two or more data sources may not always agree.

For instance, the GIW 122 may contain information from a first data source reporting that a particular server resides at a first location while also containing information from a second data source reporting that the particular server resides at a second location. Of course, because this particular server can only physically reside at a single location at a point in time, one of the reported locations within the GIW 122 is incorrect. One or more reconciliation processes are thus performed on this data (e.g., the inventory and associated information) to keep the data accurate and up-to-date. These reconciliation processes attempt to automate handling of data validation exceptions. The reconciliation framework 420 then feeds the reconciled information to the managed data systems 406, such as the application directory 120, as well as back to the GIW 122. The reconciliation framework 420 may also feed exception information generated during these processes back to the GIW 122. With this information, the GIW 122 or the reconciliation framework 420 may provide this information to a website or intranet for viewing authorized personnel.

FIG. 16 illustrates the reconciliation framework 420 from FIG. 4 in more detail. As illustrated, this reconciliation framework 420 exists on one more computing devices (e.g., servers) 1602, which include one more processors 1604, memory 1606 (e.g., volatile, non-volatile, and persistent memory), and a network interface 1608. This network interface 1608 provides access to and communication over a network (e.g., LAN, Internet, wireless, etc.). While the reconciliation framework 420 is shown stored in memory 1606, this framework is executed on processing units 1604 during runtime.

Selected components in the reconciliation framework 420 include a receiver 1610, a reconciliation module 1612, an exception generator 1614, an exception assignor 1616, and a data grading module 1618. The receiver 1610 receives data from the GIW 122, the data pertaining to the hardware, software, and telecommunications assets distributed throughout an organization. As describe above, the GIW 122 itself receives this data from multiple managed data sources 406 and multiple discovery tools 408. The reconciliation module 1612, meanwhile, compares this data from a first data source with corresponding data from a second data source to determine differences between the two. In some instances, the reconciliation module 1612 may compare corresponding data between even more data sources (e.g., three or more).

Responsive to the reconciliation module 1612 determining differences between the data reported by two sources, the exception generator 1614 generates an exception. This generated exception represents a discrepancy between the data from the first data source and the corresponding data from the second data source. The exception generator 1614 also includes an importance assignor 1620, which is configured to assign an importance level to generated exceptions. The importance level assigned to a particular exception reflects the priority of that exception relative to other exceptions and may be based, in whole or in part, on a variety of factors.

For instance, an assigned importance level may vary (e.g., increase) according to an age of the exception. That is, the reconciliation framework may track the history and age of exceptions from the time of their inception to the time of their resolution. This data may be used in assigning importance levels to a generated exception.

An assigned importance level may also vary with the type of data (e.g., asset location) to which the exception relates, as well as to whether the asset has a registered owner. For instance, an importance level may be higher if the asset currently has no registered owner or if the asset dose not currently run an application that has a registered owner.

Responsive to the generation of an exception, the exception assignor 1616 assigns one or more entities to reconcile the discrepancy and/or alter or implement workflow processes. For instance, the exception assignor 1616 may assign a person, multiple people, or a department to reconcile the exception. The exception assignor 1616 may look to the GIW 122 to determine a person responsible for the corresponding asset, at which point the exception assignor 1616 may assign that person to the exception.

In response, this person (or other assigned entity) reconciles the discrepancy. If, for example, the exception relates to a location of an asset within the organization, then the assigned person may check one or both of the locations reported by the first data source and the second data source, respectively. If one or both of these reported locations are deemed incorrect, this person may correct the reported location(s). This may include rescanning the asset, fixing the reported location within the GIW 122, or the like.

In addition or in the alternative, the person assigned to a particular exception alters or implements one or more of the workflow processes 404 discussed above. For instance, this person may require that an asset be scanned in to the GIW 122 before the asset is powered on. This person may also require that certain new assets (e.g., new servers) are only delivered to a particular location (e.g., the server room). Of course, this person may employ, alter, or otherwise reinforce multiple other workflow processes 404.

The data grading module 1618, meanwhile, grades data within the GIW 122 or within the reconciliation framework 420 to proclaim the estimated validity of the corresponding data. These grades may be stored within the GIW 122 and/or may be provided to consuming systems, such as the managed data systems 406. These grades may also be presented to human users (e.g., system administrators) to enable these users to glean the validity of the data. For instance, these grades may be presented on a website viewable by some or all employees of an organization (e.g., as part of an Intranet).

To display the estimated validity of the data, these grades typically comprise a number, letter, color, or other symbol. The estimated validity reflected by these grades increase as the corresponding data is reconciled according to the reconciliation framework 420. The estimated validity may also increase if the source of the corresponding data is deemed authoritative for that particular data. One exemplary grading system is provided below:
Grade=0(Presented to user in Black): The data has been received from an authoritative source and cleansed through the reconciliation process
Grade=1 (Presented to user in Green): The data has been received from an authoritative source but not cleansed through the reconciliation process
Grade=2 (Presented to user in Yellow): A field in a consuming system has been auto-populated from a non-authoritative source
Grade=3 (Presented Red): The data has been manually entered

FIG. 16 also illustrates exemplary components in the receiver 1610, including a database 1622 to store data 1624 from the GIW 122. This database 1622 may exist locally within the reconciliation framework 420 or this database may exist remotely. For instance, the receiver 1610 may analyze the data 1624 from within the GIW database 142 itself Whatever the database's form, the data 1624 includes data pertaining to the hardware, software, and telecommunications assets distributed throughout the organization. This data includes asset locations, asset identifications, asset serial numbers, software identifications, internet protocol (IP) addresses of assets (e.g., servers), asset hostnames, and departments to which charges associated with particular assets should be charged. This data also includes telephone numbers, member names, and an amount of telephone numbers within voicemail distribution lists, as well as emails or identifications of emails sent or received within the organization. This data also includes configurations of trader turret telephone systems (at both primary and backup locations).

In addition, the data 1624 within the database 1622 includes both managed data 1626, collected by the managed data sources 406 or the like, and discovery tool data 1628, collected by the discovery tools 408. The managed data 1626 represents data that has been collected via manual entry while the discovery tool data 1628 represents data that has been automatically collected without human intervention. The managed data 1626 includes, for instance, data from TAM 1630, cable management systems (CMS) 1632, Device DB 1634, DNS 1636, and controller 1638. The discovery tool data 1628, meanwhile, includes data from one or more software agents 1640 (e.g., Marimba, Sysinfo), SONAR 1642, switch management system (SMS) 1644, EMC Enterprise Control Center (ECC) 1646, and storage info 1648. Note that data 1624 may also include data from other managed data systems and discovery tools.

To reconcile the data 1624 within the database 1622, portions of the managed data 1626 are compared to other portions of the managed data 1626. Portions of the managed data 1626 are also compared against portions of the discovery tool data 1628. In addition, portions of the discovery tool data 1628 are compared against other portions of the discovery tool data 1628. After a discussion of an exemplary reconciliation process is described with reference to FIG. 17, FIGS. 18-23 and an accompanying discussion describe exemplary comparisons amongst the data 1624 within the database 1622.

FIG. 17 illustrates an exemplary process 1700 for reconciling data stored within the GIW 122. Process 1700 includes operation 1702, which represents the GIW 122 providing data to the reconciliation framework 420. This data may comprise some or all of the data 1624 shown within the receiver 1610 of FIG. 16. At operation 1704, the reconciliation framework 420 receives this data and, at operation 1706, compares corresponding data from two or more data sources. For instance, the reconciliation framework 420 may compare an asset's location as reported by a first data source with the same asset's location as reported by a second data source. Note that because the data pertains to some portion of the assets distributed throughout the organization, the compared data may pertain to a single asset, a group of assets, or all or substantially all of the assets.

Operation 1708, meanwhile, generates exceptions from the comparison of operation 1706. That is, when the reconciliation framework 420 finds that data from a first data source does not match corresponding data from a second data source, the reconciliation framework 420 generates an exception. For instance, if a server's reported current location differs amongst two different data sources, then the reconciliation framework 420 generates an exception. Operation 1708 may also generate an exception report that lists the generated exceptions.

At operation 1710, one or more of the generated exceptions are reconciled. For instance, if data differs between a first and a second data source, and if the first data source is deemed authoritative for that particular data, then the second data source may be altered to reflect the data reported by the first data source. This may be true in instances where both data sources are managed data sources. Alternatively or additionally, a person or other entity may be assigned to reconcile one or more exceptions. This may be true in instances where one data source is a managed data source and the other data source is a discovered data source.

Operation 1712 then represents that the reconciliation framework 420 or a person assigned to a generated exception alters or implements workflow processes 404 as discussed above. For instance, the framework or the person may require that an asset be scanned in to the GIW 122 before the asset is powered on or may require that certain new assets (e.g., new servers) only be delivered to a particular location (e.g., the server room).

Having matched data and possibly generated exceptions and a corresponding exception report, the reconciliation framework 420 provides some or all of this data to the GIW 122 at operation 1714. The GIW 122 receives this data at operation 1716. In addition, note that the reconciliation framework 420 or some other entity may alternatively or additionally store this data. At operation 1718 the GIW 122 and/or the reconciliation framework 420 then grades this data, possibly according to the processes discussed above. Additionally, note that this grading process may also occur within some other entity.

Finally, operation 1720 represents that the reconciliation framework 420 and/or the GIW 122 posts the data, possibly to a website that is accessible by employees of the organization or other authorized personnel. In some instances, the data is posted upon a website (e.g., an Intranet of the organization) that may only be accessed by these employees or authorized personnel.

Having discussed an overview of one exemplary reconciliation process, FIGS. 18-20 illustrate a process 1800 for comparing corresponding data pertaining to an organization' assets from two or more different data sources. This process may be employed to reconcile data pertaining to hardware devices such as servers, workstations, or any other equipment maintained by an organization. If the compared data pertaining to the asset matches, then this data is considered to be reconciled and correct. If not, an exception is generated. This exception may then be assigned an importance level, stored, and possibly aged to increase the assigned importance level with time. Note that these comparisons may be done singularly or in combination (e.g., serially, in parallel, or in a cascading fashion). That is, a single comparison may be made or multiple comparisons may be made.

When done in a cascading fashion, multiple pieces of data about an asset are reconciled until the asset is considered fully reconciled. For instance, a group of servers may be examined to determine if two data sources report matching Internet Protocol (IP) addresses for those servers. For those servers whose reported IP addresses do indeed match, asset tags for those servers as reported by two different data sources may be compared in an attempt to find matching reported asset tags. Of those servers having matching reported asset tags, hostnames are checked, before secondary interface names are checked. Finally, reported locations of the assets may be checked. If an asset's reported locations match (and, hence, the asset's reported IP addresses, asset tags, hostnames, and secondary interface names match), then the asset is considered fully reconciled. Note, however, that multiple other types of data may be compared in addition or in the alternative during this cascading process.

In addition, note that each of the data sources listed in process 1800 are merely exemplary, and other data sources may also be employed. As illustrated, this process includes operation 1802, which represents generation of a SONAR IP report. SONAR is a discovery tool that automatically collects data without human intervention. As such, SONAR scans the IP addresses within the organization that the tool can reach. By so scanning, SONAR determines which IP addresses are active and which are inactive. In addition, SONAR attempts to connect to the active IP addresses and reach a login prompt for the corresponding asset (e.g., a server). From the login prompt, SONAR attempts to determine one or more characteristics of the corresponding asset. For instance, SONAR may determine whether the asset runs a UNIX™ or a Windows™ operating system.

Operation 1804, meanwhile, represents generation of a software agent IP report. These software agents may include Marimba for assets running Windows™ and/or Sysinfo for assets running Unix™ (or Linux™). At operation 1806, the reconciliation process then compares the SONAR report with the agent-generated report(s). For instance, IP addresses reported by Marimba are compared with those IP addresses from the SONAR report that have been determined to run Windows™. If Marimba does not report an IP address that SONAR expects Marimba to list, then an agent may be missing on that corresponding asset. As such, operation 1808 represents generation of an exception. Similarly, the IP addresses reported by Sysinfo are compared with those IP addresses from the SONAR report that have been determined to run UNIX™. If Sysinfo does not report an IP address that SONAR expects Sysinfo to list, then an agent may be missing on that corresponding asset. Again, operation 1808 accordingly generates an exception. This exception may be reconciled by installing an agent on that particular hardware asset.

If, however, Marimba lists an IP address that SONAR also lists as corresponding to an asset that runs Windows™, then operation 1810 considers that IP address to be reconciled. Similarly, operation 1810 considers an IP address to be reconciled if Sysinfo lists an IP address that SONAR also lists as corresponding to an asset that runs UNIX™.

Next, operation 1812 represents examining asset tags reported by agents such as Marimba and Sysinfo. Each asset tag, which identifies a corresponding asset, may be located within a basis input/output system (BIOS) of the asset. The agents may therefore examine the BIOS of each asset and generate a report of corresponding asset tags. Again, Marimba may examine Windows™-based assets and Sysinfo may examine UNIX™-based assets. Operation 1814 then represents examining asset tags reported by TAM, which generates and maintains a listing asset tags. The asset tags maintained in TAM may stem from asset tags that are manually placed (in the form of a sticker or the like) on the chassis of an asset (e.g., a hardware asset such as a server). A person may use a hand-held scanner or the like to scan this asset tag, which then appears within the TAM asset-tag listing.

At operation 1816 the reported asset tags are then compared. If an asset tag reported by an agent does not match an asset tag listed in TAM, then operation 1818 generates an exception. Reported asset tags for corresponding assets may not match due on human error (e.g., replacing motherboards within a hardware asset's chassis, the chassis having an asset tag attached to the chassis in the form of a sticker). In some instances, an asset tag listed in TAM is deemed authoritative and, as such, the agent-reported asset tag is changed to reflect this TAM-reported asset tag. For assets having asset tags that match, however, these corresponding asset tags are considered reconciled at operation 1820.

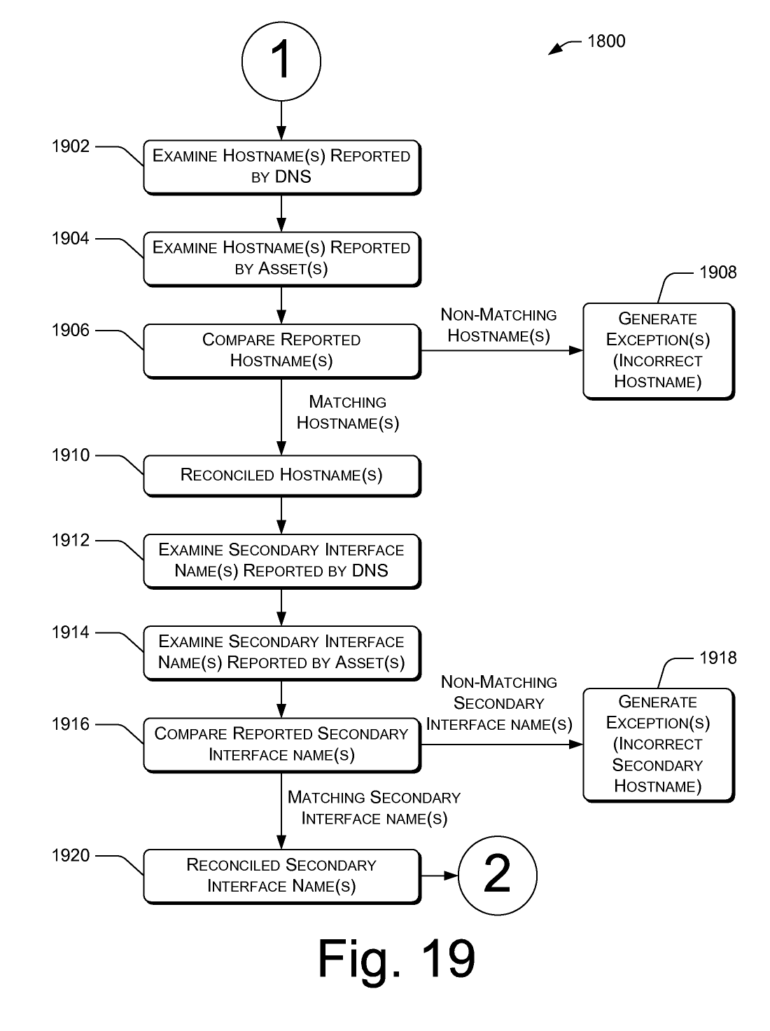

FIG. 19 continues the illustration of the process 1800. Here, operation 1902 represents examination of hostnames for assets as reported by a domain name system (DNS). DNS contains a manually-entered list of hostnames for hardware assets such as servers. Operation 1904 represents examination of corresponding asset hostnames as reported by the assets themselves. For instance, a hardware asset such as a server is initially configured with (e.g., manually) and contains a hostname for itself. This server or the agent running thereon may report this hostname to the reconciliation framework for examination. At operation 1906, the two reported hostnames are compared. If the reported hostnames for a certain asset do not match, then operation 1908 generates an exception. In some instances, the hostname reported by the asset itself is deemed authoritative. As such, the hostname reported by DNS may be altered to reflect the asset-listed hostname. If the reported hostnames for another asset do match, meanwhile, then operation 1910 represents that the hostname is considered to be reconciled.

Operation 1912 represents examination of secondary interface names as reported by DNS. A hardware asset such as a server may have multiple secondary network interfaces. Again, DNS contains a manual listing of secondary network interface names for assets within the organization. The assets themselves, meanwhile, have also been initially configured with and contain secondary network interface names for the asset's interfaces. These asset-reported names are thus examined at operation 1914. Operation 1916, then, represents comparison of the two sets of reported secondary interface names. If a secondary interface name does not match, then operation 1918 generates an exception. The name reported by the asset itself is deemed authoritative in some instances and, as such, the DNS listing may be so altered. For matching names, meanwhile, operation 1920 represents that the asset's secondary interface name(s) are reconciled.

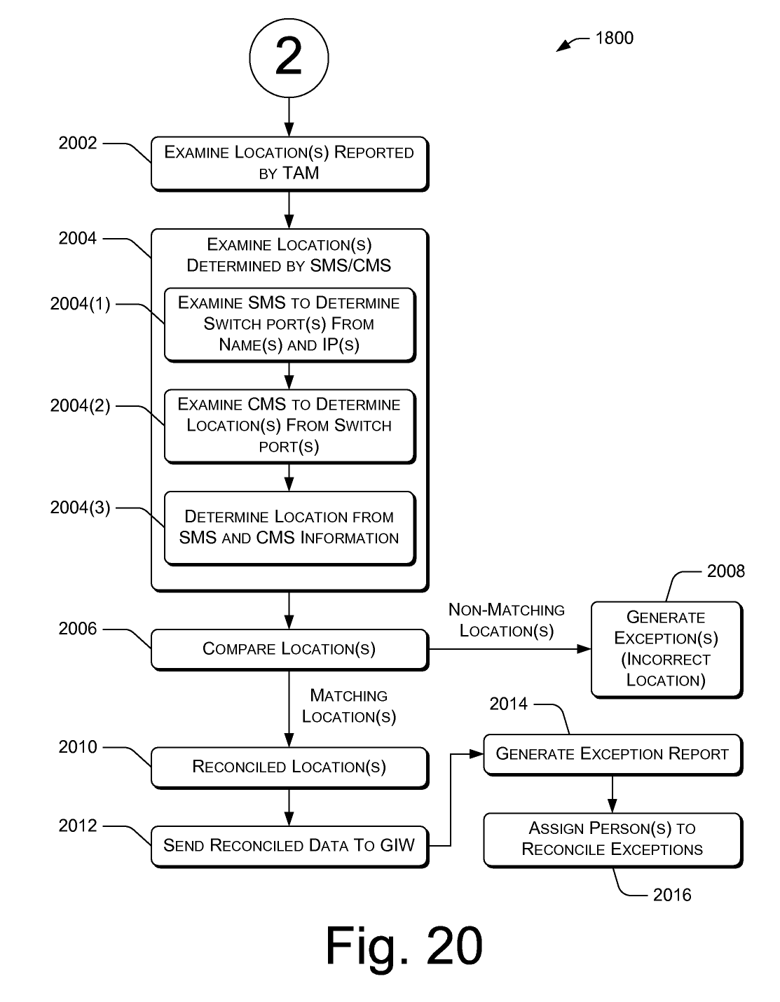

FIG. 20 continues the illustration of the process 1800 and includes operation 2002, which represents examination of asset locations as reported by TAM. TAM contains a listing of assets, according to asset tags, along with a location of each asset according to the last time the asset was physically scanned (e.g., by a hand-held scanner). Here, an agent (e.g., Marimba or Sysinfo) reports an asset tag, with which the asset's location is identified according to TAM. Operation 2004 then represents that a location for the asset is determined with reference to switch management system (SMS) as well as cable management systems (CMS).

Operation 2004 comprises a series of sub-operations 2004(1), (2), (3), which together enable a determination of an asset's location according to the SMS/CMS combination. Operation 2004(1) first represents examination of SMS, which links an asset's switch port(s) with the asset's name and IP address. Operation 2004(2), meanwhile, represents examination of CMS, which links the asset's switch port(s) to the asset's location. With information from both SMS and CMS, operation 2004(3) then determines the asset's purported location.

At operation 2006, the location reported by TAM is compared with the location determined by the SMS/CMS combination. If these locations do not match, then operation 2008 generates an exception. As discussed below, a person may be assigned to reconcile the exception by, for instance, examining each reported location to determine whether the TAM location or the SMS/CMS location is incorrect (or whether both are incorrect). If TAM is incorrect, then the location reported by the asset (and listed in TAM) may be manually altered to reflect the proper location (e.g., by scanning in the asset with a handheld scanner at the proper location). If however, the SMS/CMS location is incorrect, then one or both of the SMS information and the CMS information is likely incorrect. Both may thus be checked to determine the root source of the exception. Once the root source is identified, the root is fixed and the exception reconciled. Responsive to matching reported locations, meanwhile, operation 2010 represents that the asset's location is considered reconciled.

Having reconciled exemplary data pertaining to assets within the organization, process 1800 also includes operation 2012, which represents sending the reconciled data to the GIW 122. This operation may alternatively merely send a report identifying the reconciled data. Operation 2014 then represents generation of an exception report, which may similarly be provided back to the GIW 122. Finally, operation 2016 assigns one or more people or other entities to reconcile one or more of the generated exceptions. As discussed above, this reconciliation may include altering a reported value of a data source and/or altering or implementing a workflow process to avoid future exceptions of a same type as the generated exception.

Once a hardware asset such as a server is reconciled according to this process 1800, then the server appears within the application directory 120 to enable registration of the server against applications running within the organization. In some instances, a non-reconciled asset such as a server does not appear within the application directory 120, such that the application developers 432 may not register this server against applications. In other instances, only certain information about an asset such as the server need be reconciled (or at least provided by one data source) before the server appears in the application directory 120. For instance, if the server has a reconciled hostname, then the server may appear in the application directory 120 even if the server's location is not reconciled.

Once an asset such as server appears within the application directory 120, then an exception may be generated if no applications are registered against that server. Responsive to such a “no-app owner” exception, the server may be targeted for decommission. This targeting aims to increase awareness of the use of the application directory 120 and aims to encourage registration of applications within the directory.

Another potential type of data that may be reconciled includes an identification of a department to which an asset's expenses should be charged. One or more data sources may maintain this identification of the department. With use of this identification, charges such as storage costs, maintenance, and the like are charged back to the identified department. This identification may thus be reconciled by comparing corresponding data from a first data source and a second source, such as Controller and TAM described above. Similar to the reconciliations described above, an exception may be generated in response to non-matching data or in response to missing data (i.e., no charge-back department identified). An exception may also be generated in response to an invalid identification, such as one that identifies a department within the organization that has closed.

FIG. 21 illustrates another exemplary process 2100 for comparing corresponding data pertaining to an organization' assets from two or more different data sources. This process may be employed to reconcile data pertaining to hardware devices such as network devices (e.g., network switches, router, remote monitoring (RMON) probes, etc.). Process 2100 includes operation 2102, which represents examining data reported by TAM. As discussed above, TAM comprises a managed inventory for the organization's assets. TAM may list an IP address, a type of device, a hostname, an asset tag, a location, and/or a serial number for each of these assets.

The organization, however, may also maintain a second managed inventory for network devices. Here, a data source entitled Device DB comprises this second managed inventory. Device DB may include, for each asset, an IP address, type of device, a hostname, and the like. Operation 2104, then, represents examination of data reported by Device DB. At operation 2106, the data reported by TAM is compared with the data reported by Device DB for the organization's network assets. As such, some or all of the data reported by these two managed inventories may be reconciled against one another. If some of the compared data does not match, then operation 2108 generates one or more exceptions. These exceptions may be reconciled in the manner reported above or in other ways. For instance, if one of the inventories is an authoritative source for certain data (e.g., hostname), then the data listed by the other inventory may be altered to reflect the authoritative data. Operation 2110, meanwhile, represents that data is considered reconciled responsive to matching TAM and Device DB data.

Operation 2112 then represents generation of a SONAR IP report, as discussed above in regards to process 1800. Here, however, SONAR reports IP addresses of network devices within the organization. At operation 2114, the IP addresses reported SONAR are compared with the IP addresses reported by Device DB. If some or all of these IP addresses for these network devices do not match, then operation 2116 generates an exception. If some or all of these addresses, match, however, then operation 2118 considers these addresses to be reconciled.

Process 2100 then includes operation 2120, which represents the sending of the reconciled data to the GIW 122. The GIW 122 may store this data for use by one or more data consumers as discussed above and illustrated by the architecture of FIG. 4. In addition, the reconciliation framework 420, the GIW 122, or some other entity may grade this reconciled data (and possibly the non-reconciled data). Operation 2122, meanwhile, generates an exception report listing the exceptions generated throughout process 2100. This report may also be provided to the GIW 122. Finally, operation 2124 represents that one or more people are assigned to reconcile the generated exceptions. Note that in some instances, the exceptions may be automatically reconciled. For example, if one data source (e.g., TAM) is considered authoritative, then that data source's data may be used to alter another data source's data responsive to non-matching data.

FIG. 22 illustrates yet another exemplary process 2200 for comparing corresponding data pertaining to an organization' assets from two or more different data sources. This process may be employed to reconcile data pertaining to hardware devices such as storage devices (e.g., storage servers, storage switches, storage arrays, etc.). Some of these assets employed for storage may undergo the reconciliation process 2200 as well as other reconciliation processes described above. For instance, a storage server may additionally undergo the reconciliation process 1800 described with reference to FIGS. 18-20, while a storage switch may undergo the reconciliation process 2100 described with reference to FIG. 21.

Process 2200 includes operation 2202, which represents examination of data reported by ECC (an exemplary data source described above). ECC collects data from storage assets on a periodic basis (e.g., nightly). This data may include asset serial numbers, hostnames, IP address, device types, as well as other information discussed above. At operation 2204, similar types of data reported by TAM are examined. Operation 2206 then compares the data reported by ECC with corresponding data reported by TAM. This compared data may include asset serial numbers, hostnames, IP addresses, device types, and/or the like. Operation 2208 then generates an exception responsive to non-matching corresponding data, while operation 2210 represents the reconciliation of matching data.

Operation 2212 then represents examination of data reported by Device DB. This data may comprise data similar to that reported by TAM, although for network devices. Operation 2214 then represents comparison of the data reported by Device DB with the corresponding data reported by ECC. Again, operation 2216 generates an exception responsive to non-matching data, while operation 2218 represents reconciled data that has been matched between the two data sources.

ECC may additionally report on configuration information for storage assets such as storage arrays. In addition, a software agent such as Marimba or Sysinfo may similarly maintain configuration information for a storage asset that the agent runs on. For instance, imagine that a storage array is configured such that 100 Gigabytes (GB) of storage is to be used by a now-decommissioned server within the organization. Because this server is no longer is service, this storage space should be released. As such, configuration information reported by ECC may be reconciled with configuration information reported by a running software agent to reconcile the configuration information and release the storage.

To reconcile configuration information for storage assets, process 2200 includes operation 2220, which represents generation of one or more agent configuration reports. Operation 2222, meanwhile, represents comparison of these agent reports with configuration information reported by ECC. Responsive to non-matching configurations, operation 2224 generates exceptions. Operation 2226, meanwhile, represents matching and reconciled configurations. Similar to other processes described above, an exception report may also be generated. One or more people may also be assigned to reconcile the generated exceptions and/or to alter or implement workflow processes to correct the root problem.

FIG. 23 illustrates yet another exemplary process 2300 for comparing corresponding data pertaining to an organization' assets from two or more different data sources. Process 2300, however, enables reconciliation of voicemail distribution lists, email distribution lists, or the like. Imagine, for instance, that an organization maintains one or more voicemail distribution lists on two or more servers within the organization. As is known, each voicemail distribution lists maintains certain telephone numbers or extensions within the organization to which a voicemail is to be sent. Each list therefore maintains a certain amount of telephone numbers, a certain listing of members, and certain telephone numbers. One list, for example, may list a telephone number for each employee within the organization. Another list, meanwhile, may list only partners within the organization.

With this in mind, attention is returned to FIG. 16. Here, the database 1622 within the reconciliation framework 420 includes data from the two or more servers that maintain the distribution lists. This data is then compared, for instance, according to the process 2300 illustrated by FIG. 23. While FIG. 23 describes this reconciliation with reference to voicemail distribution lists, other types of distribution lists or other data may similarly be reconciled via this process.

Process 2300 includes operation 2302, which represents receiving data from a first voicemail server. This data includes information about one or more voicemail distribution lists. Operation 2304 then receives data from a second voicemail server. The reconciliation framework 420 may receive the data from both the first and second voicemail servers. At operation 2306, the voicemail distribution lists (or some portion thereof) from the first and second servers are compared. If the compared data does not match, then operation 2308 generates an exception. Similar to the processes described above, an exception report may accordingly be generated. One or more people may likewise be assigned to reconcile the non-matching data and/or to alter or implement workflow processes. Conversely, the data may be automatically reconciled (e.g., by altering a non-authoritative server's data with an authoritative server's data). Operation 2310, meanwhile, represents that matching data is considered reconciled. Also similar to the processes discussed above, this reconciled data may be graded and provided to the GIW 122.

Note that operation 2306 may itself comprise a series of sub-operation. A first sub-operation 2306(1) represents comparing actual telephone numbers within a voicemail distribution list reported by the first server with actual telephone numbers within the same voicemail distribution list reported by the second server. Response to non-matching numbers, an exception may be generated. Next, a sub-operation 2306(2) represents comparing member names listed in the voicemail distribution list between the two servers. Again, an exception may be generated. Finally, a sub-operation 2306(3) represents comparing an amount (e.g., a number or a size of stored information) of telephone numbers within the voicemail distribution list maintained by both servers. Response to a non-matching amount, an exception is generated.

In addition to distribution lists, this process 2300 may be employed to reconcile other data. For instance, two servers for email storage may be compared to determine whether these servers contain a same amount of emails as well as the same emails themselves. For instance, imagine that an organization employs an exchange server to receive all emails sent and received within the organization. Imagine also that the organization employs a retention server to store a backup copy of these sent and received emails. Data about these emails (e.g., total size, number of emails, etc.) may be provided to the reconciliation framework 420. The reconciliation framework 420 may then employ a reconciliation process to determine if the exchange server and the retention server are reconciled. If not, exceptions may be generated, people may be assigned to the exceptions, and/or workflow processes may be altered or implemented.

Additionally, a reconciliation process similar to the process 2300 described above may be used to reconcile a configuration of a trader turret telephone system. Traders typically employ these trader turret telephone systems, each of which includes a configuration that need be maintained at a backup site. This configuration includes dial plans, stored telephone numbers, and the like. As such, a backup trader turret telephone system may be employed to backup a primary telephone system. The configuration of the primary and the backup systems may be reconciled to determine a validity of the backup system. Responsive to a non-matching configuration, an exception may be generated in order to enable reconciliation of this data.

As discussed above with reference to FIG. 17, data generated during one or more of the above reconciliation processes may be posted or made available for viewing by employees of an organization or the like. A website may, for instance, present statistics regarding a number of matching pieces of data between corresponding data reported by two or more data sources. The website may also present a number of exceptions between the corresponding data reported by these data sources.

FIG. 24 illustrates an exemplary reconciliation page 2400 served by the reconciliation framework 420 or the GIW 122. Here, the reconciliation page 2400 exists as a part of an organization's intranet or the like. The page 2400 includes multiple tabbed panes including a tab 2402 for access to the organization's intranet home page and a tab 2404 for access to a primary pane 2406 of the reconciliation framework. This primary pane 2406 includes a navigation menu 2408 and a content area 2410.

The navigation menu 2408 provides a set of links, including a link to a reconciliation home page. This menu 2408 also provides a “source verification” link, which enables a user to view data reported from multiple data sources. Similarly, a user may select a link entitled “Management Reports” from the menu 2408 to view the aging and trending of exceptions. These reports may be useful in tracking exceptions and in choosing how to alter and implement workflow processes in response to the exceptions.

The content area 2410, meanwhile, includes a graph 2412 that graphically displays reconciliation information, as well as textual information 2414 that textually displays the information shown in the graph 2412. This textual information 2414 includes an identification 2416 of the data sources being compared for reconciliation purposes. Here, the identification 2416 shows that data from “data source 1” is being compared with data from “data source 2”. This data could comprise any of the data discussed above (e.g., IP addresses, asset locations, etc.) and these data sources could comprise any of the managed data sources or discovery tools also discussed above (e.g., TAM, SONAR, etc.). In addition, the textual information 2414 includes an identification 2418 of the total number of assets analyzed, an identification 2420 of the number of matching pieces of data, and an identification 2422 of the number of generated exceptions. Here, for instance, the textual information 2414 may be illustrating that of 13,987 assets analyzed throughout an organization, 11,234 server locations match as reported by the first and second data sources.

The graph 2412, meanwhile, graphically illustrates the statistics shown via the textual information 2414. The graph 2412 thus includes an identification 2424 of the number of matching pieces of data as well as an identification 2426 of the number of generated exceptions. The graph 2412 also includes a legend 2428 to help a user understand the graphically-presented data.

Finally, the content area 2410 of the reconciliation page 2400 includes a history 2430 of the currently-illustrated and currently-reported data. As the history 2430 shows, this data from the first and second data sources has been compared on Jun. 26, 2007, Jul. 15, 2007, and Aug. 20, 2007. With use of the illustrated history 2430, a user may examine how the data reported by the two data sources as a whole has become more (or less) reconciled with time.

FIG. 25 illustrates another exemplary reconciliation page 2500 that illustrates exceptions for different types of data that pertain to a particular type of asset within an organization. Here, the reconciliation page 2500 is entitled “Server Reconciliation” and thus illustrates reconciliation information for some or all of the organization's servers, which may be distributed locally and/or globally. Additionally, the illustrated page 2500 depicts a cascading approach for reconciling the different types of data that pertain to the organization's servers. As described above, this cascading approach means that a first type of data is analyzed for a server and, if that first type of data is reconciled for that server, then a second type of data is analyzed for that server. If, however, the first type of data is not reconciled, then the second type of data is not analyzed for that particular server. This may continue throughout numerous types of data until the numerous types of data are reconciled for none or more servers. These servers (if any) are then considered to be fully reconciled. While the illustrated reconciliation page 2500 employs this cascading approach, this page need not. Instead, each of the illustrated comparisons may be compared independently or in another combination.

The reconciliation page 2500 includes a graphical area 2502 for illustrating reconciliation information graphically and a textual information area 2504 for illustrating this same or similar information textually. In the illustrated embodiment, the first type of data being compared is entitled “Agents: Discovered IP Addresses v. Agent Data” 2506. This comparison may consist of first discovering each server IP address via a SONAR-generated IP report. As discussed above, SONAR attempts to connect to the active IP addresses and reach a login prompt of each active address to determine whether the server runs UNIX™ or a Windows™. Software agents are then called to report on these live IP addresses. For server IP addresses corresponding to UNIX™, Sysinfo is checked to see if Sysinfo lists the corresponding server. Marimba, meanwhile, is checked for server IP address corresponding to Windows™. If an agent does report a server where expected, then the data is considered to be matching and reconciled between SONAR and the agent. If the agent does not report a server where expected, however, then an exception is generated. As the textual information illustrates, out of an organization's 13,987 turret servers, 11,234 of them have discovered IP address that are the same as that reported by a corresponding agent, while 2,753 result in exceptions. A graph 2508 visually depicts this information.

The reconciliation page 2500 also compares reported asset tags, as depicted by a title “Asset Tags: Agent Data v. TAM Inventory” 2510. As shown, the total numbers of servers checked for matching assets tags is 11,234, which is the same number of servers that passed the analysis and comparison described directly above and shown in the graph 2508. As described above, an asset tag of each of these servers may be reported both by an agent running on the server (e.g., Sysinfo or Marimba) as well as by TAM's inventory. Here, 9,034 of the remaining servers are shown to have matching asset tags, while 2,200 servers are shown to each generate an exception. Again, the page 2500 also includes a graph 2512 to impart this information to the user.

Next, hostnames of the remaining servers are checked and reported in an area entitled “Network Interfaces: Server Name Resolution v. DNS” 2514. Also as discussed above, an agent running on each server may report a hostname that the corresponding server has been configured with and contains. This is then compared against the corresponding hostname listed in DNS. Here, 7,989 of the servers contain configured hostnames that match the hostnames reported in DNS, while 1,045 servers do not. A graph 2516 also illustrates this information graphically.

Next, the reconciliation page 2500 illustrates results of a comparison entitled “Secondary Interfaces: Server Name Resolution v. DNS” 2518. Again, each server within the organization likely has multiple secondary network interfaces. These secondary interface names as reported by DNS are thus compared with the secondary interface names that the servers were initially configured with. Here, 6,022 of the servers contain secondary interface names that match while 1,045 servers do not, as illustrated textually as well as by a graph 2520.

Finally, the reconciliation page 2500 illustrates reconciliation information relating to the locations of the remaining 6,022 servers. This information is conveyed textually in a screen area entitled “Location: TAM v. Cable Management/Switch Management” 2522. As discussed above, TAM reports a location for each of the servers, which is compared against a corresponding location determined by the CMS and SMS data sources. As illustrated textually and by a graph 2524, 3,822 servers have matching reported locations while 2,200 do not. Note that because the data for each these 3,822 servers matches for each comparison illustrated in FIG. 25, these servers may be deemed “fully reconciled”. That is, each compared data point matches as between two or more data sources. As such, it is very likely that the reported data pertaining to these servers is correct.

In some instances, the reconciliation page 2500 enables a user to view details about the comparisons between the data pertaining to the organization's assets. FIG. 26 illustrates such an exemplary reconciliation details page 2600 that presents details about the data comparison entitled “Agents: Discovered IP Addresses v. Agent Data” 2506. This details page 2600 illustrates information 2602 about Windows™ server IP addresses, as well as information 2604 about Unix™/Linux™ Server IP addresses. This former information includes a graph 2606 that shows a number of matching agents and a number of missing agents for Windows™ server IP addresses, as well as region information 2608 for matching agents and region information 2610 for missing agents. The information 2604 about Unix™/Linux™ Server IP addresses similarly includes a graph 2612 hat shows a number of matching agents and a number of missing agents for Unix™/Linux™ Server IP addresses. This information also displays region information for matching and missing agents (not currently illustrated by the page 2600). This details page 2600 thus shows information in addition the matching/missing agent data depicted in FIG. 25.

The region information 2608 shows a breakdown, by region, of servers whose agents have been matched. For instance, this organization currently has 2,754 servers within the Americas whose discovered IP addresses report a Windows™-based server and whose IP addresses are similarly reported by Marimba. Two-hundred-thirty-three servers whose agents have not been matched, meanwhile, similarly reside within the Americas, as illustrated by the region information 2610 showing a breakdown of non-matched agents.

In addition to reporting these details, this region information 2608, 2610 enables a user to view still further details about this reconciliation information. As such, the numbers listed within this region information 2608, 2610 include hyperlinks to more detailed information. For instance, if a user of the details page 2600 uses a point-and-click device or the like to select the link entitled “233”, a web page will present to the user detailed information about these Americas-based servers whose agents have not been matched.

FIG. 27 depicts an exemplary reconciliation details page 2700 that illustrates these details in response to this user selection. This details page 2700 presents a title 2702, as well as information 2704 about these servers. This information 2704 includes an “Agent Status” 2706. Because an agent of each of the 233 servers has not been matched, the agent status for each of these servers currently states “Not Matched (Marimba info not found)”. The detailed information 2704 may also present an “Asset Tag Status” 2708 to the user, although in other embodiments this status may not be included. Here, because the servers' agents cannot be reached, each asset tag may not be reconciled (against TAM or the like).

The details page 2700 also illustrates a data field for an “IP Region” 2710, an “IP Address” 2712, and an “IP DNS Name” 2714 for each of the 233 servers. Because the user selected the link associated with Non-matched-agent servers located in the Americas, the IP Region for each server is illustrated as “Americas”. In addition, each of these servers is shown to have an IP address (possibly reported by SONAR), while an IP DNS Name is illustrated for some of these servers. Finally, note that while FIGS. 26 and 27 illustrate exemplary details for a single data comparison (Agents: Discovered IP Addresses v. Agent Data), other details may be similarly or additionally illustrated for other data comparisons.

With reference back to FIG. 4, the reconciliation framework 420 thus enables performance of one or more reconciliation processes on data stored within the GIW 122. This data typically pertains to one or more of hardware, software, and telecommunications assets distributed throughout an organization. That is, this data may pertain to a single hardware, software, or telecommunications asset, or it may pertain to multiple assets in any combination.

These reconciliation processes, meanwhile, compare corresponding data reported by two or more data sources in an attempt to keep the data accurate and up-to-date. In addition, these reconciliation processes attempt to automate handling of data validation exceptions. The reconciliation framework 420 then feeds the reconciled information to the managed data systems 406, such as the application directory 120, as well as back to the GIW 122. The reconciliation framework 420 may also feed exception information generated during these processes back to the GIW 122. The GIW 122 and/or the reconciliation framework 420 may then post the reconciliation information to a website or the like for consumption by employees of the organization or other authorized personnel.

Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for reconciling data within a global inventory warehouse that maintains a global inventory of all or substantially all of hardware, software, and telecommunications assets distributed throughout an organization, comprising:
receiving data from the global inventory warehouse and maintained by a first data source, the data pertaining to a portion of the hardware, software, and telecommunications assets distributed throughout the organization;
receiving data from the global inventory warehouse and maintained by a second data source, the data pertaining to the portion of the hardware, software, and telecommunications assets distributed throughout the organization; and
comparing the data maintained by the first data source to the data maintained by the second data source effective to determine differences between the data maintained by the first data source and the data maintained by the second data source.

2. A method as recited in claim 1, wherein the data pertaining to the portion of the hardware, software, and telecommunications assets comprises a location of one of the hardware, software, and telecommunications assets.

3. A method as recited in claim 1, wherein the data pertaining to the portion of the hardware, software, and telecommunications assets comprises an identification of software running on computing devices distributed throughout the organization.

4. A method as recited in claim 1, wherein the data pertaining to the portion of the hardware, software, and telecommunications assets comprises one or more of: (1) internet protocol (IP) addresses of servers distributed throughout the organization; (2) hostnames of servers distributed throughout the organization; (3) a department of the organization to which costs associated with the portion of the hardware, software, and telecommunications assets are charged; (4) a location, type, serial number, or hostname of a network switch, router, or remote monitoring (RMON) probe; (5) telephone numbers listed in a voicemail distribution list; (6) member names listed in the voicemail distribution list; (7) an amount of telephone numbers listed in the voicemail distribution list; (8) emails sent or received within the organization, or (9) a configuration of a trader turret telephone.

5. A method as recited in claim 1, wherein the first data source comprises a managed data source that receives the data pertaining to the portion of the hardware, software, and telecommunications assets by manual entry of the data.

6. A method as recited in claim 1, wherein the second data source comprises a discovery tool that collects the data pertaining to the portion of the hardware, software, and telecommunications assets automatically without human intervention.

7. A method as recited in claim 1, wherein the global inventory warehouse is configured to grade the data, the grade being based, at least in part, on whether the data has been reconciled or whether the data has been deemed authoritative.

8. A method as recited in claim 1, further comprising altering the data maintained by the first data source or the second data source.

9. A method as recited in claim 1, further comprising:
generating an exception in response to determining one or more differences between the data maintained by the first data source and the data maintained by the second data source; and
assigning a person to reconcile the data pertaining to the portion of the hardware, software, and telecommunications assets.

10. A method as recited in claim 1, further comprising:
generating an exception in response to determining one or more differences between the data maintained by the first data source and the data maintained by the second data source; and
altering or implementing a workflow process to avoid exceptions of a same type as the generated exception.

11. A method comprising:
comparing a first set of data collected by a managed data source with a second set of data collected a discovery tool, the first set of data being collected by the managed data source via manual entry by one or more human users and the second set of data being automatically collected by the discovery tool without human intervention;
generating an exception responsive to determining a difference between the first set of data and the second set of data during the comparing; and
assigning a person to reconcile the difference.

12. A method as recited in claim 11, wherein the first and second sets of data pertain to one or more of a hardware, a software, or a telecommunication asset distributed throughout an organization.

13. A method as recited in claim 11, wherein the first and second data sets are stored within a global inventory warehouse that maintains an identity of all or substantially all of hardware, software, and telecommunications assets distributed throughout the organization.

14. A method as recited in claim 11, further comprising:
determining a source of the exception; and
implementing a workflow process to correct the source of the exception effective to avoid future exceptions of a same type as the generated exception.

15. A method as recited in claim 11, further comprising:
generating an exception report containing differences between the first set of data and the second set of data; and
posting the exception report on a website accessible by at least some employees of the organization.

16. A method as recited in claim 11, further comprising assigning an importance level to the generated exception, the importance level reflecting a priority of the generated exception relative to other exceptions and being based, at least in part, on an age of the generated exception.

17. A method as recited in claim 11, further comprising assigning an importance level to the generated exception, the importance level reflecting a priority of the generated exception relative to other exceptions and being based, at least in part, on an age of the generated exception, and wherein the assigned importance level for the generated exception increases, relative to the other exceptions, with the age of the generated exception.

18. A computing system, comprising:
memory residing within one or more computing devices; and
a reconciliation framework stored in the memory, comprising:
a receiver to receive data from a global inventory warehouse that maintains an identification of all or substantially all hardware, software, and telecommunications assets distributed throughout an organization; and
a reconciliation module to determine differences between data collected by a first data source and corresponding data collected by a second data source, the data collected by the first and second data sources pertaining to at least some of the hardware, software, and telecommunications assets.

19. A computing system as recited in claim 18, wherein:
the data collected by the first and second data sources comprises an identification of multiple hardware assets within the organization;
the first data source comprises a discovery tool to automatically scan Internet Protocol (IP) addresses to identify each of the multiple hardware assets within the organization; and
the second data source comprises a software agent to identify each of the multiple hardware assets within the organization.

20. A computing system as recited in claim 18, wherein:
the data collected by the first and second data sources comprises an asset tag for each of multiple hardware assets within the organization, each of the asset tags identifying a corresponding hardware asset;
the first data source comprises a managed data source containing the asset tag for each of the multiple hardware assets within the organization; and
the second data source comprises a software agent to locate the asset tag for each of the multiple hardware assets by examining a basic input/output system (BIOS) of each of the multiple hardware assets within the organization.

21. A computing system as recited in claim 18, wherein:
the data collected by the first and second data sources comprises a hostname for each of multiple hardware assets within the organization;
the first data source comprises each of the multiple hardware assets within the organization, wherein each of the multiple hardware assets within the organization have been configured with and contain a corresponding internal hostname; and
the second data source comprises a managed data source containing a hostname for each of the multiple hardware assets within the organization.

22. A computing system as recited in claim 18, wherein:
the data collected by the first and second data sources comprises a location for each of multiple hardware assets within the organization;
the first data source comprises a managed data source containing a location for each of the multiple hardware assets within the organization; and
the second data source comprises a managed data source and a discovery tool that together enable determination of a location for each of the multiple hardware assets within the organization.

23. A computing system as recited in claim 18, wherein:
the data collected by the first and second data sources comprises an amount of telephone numbers within a voicemail distribution list, members of the voicemail distribution list, or telephone numbers within the voicemail distribution list;
the first data source comprises a first server to maintain the data; and
the second data source comprises a second server to maintain the data.

24. A computing system as recited in claim 18, wherein:
the data collected by the first and second data sources comprises emails sent or received within the organization or information about the emails;
the first data source comprises an exchange server to receive the emails sent or received within the organization; and
the second data source comprises a retention server to store the emails sent or received within the organization.

25. A computing system as recited in claim 18, further comprising:
an exception generator to generate an exception in response to the reconciliation module determining a difference between the data collected by the first data source and the corresponding data collected by the second data source;
an importance assignor to assign importance levels to the generated exception, the assigned importance levels indicative of a priority of the generated exception relative to other generated exceptions;
an exception assignor to assign an entity to reconcile the generated exception; and
a data grading module to assign a grade to the data collected by the first data source and the corresponding data collected by the second data source, the grade indicative of a validity of the data.
